(19) United States
(12) Patent Application Publication
(10) Pub. No.: US 2026/0244789 A1
(43) Pub. Date: Aug. 20, 2026

(54) API-CENTRIC DATA MASKING WITH DYNAMIC USER-LEVEL CONTROL

(71) Applicant: Reltio, Inc., Redwood Shores, CA (US)

(72) Inventors: Sergio Javier Abraham, Barcelona (ES); Saurabh Agarwal, Bengaluru (IN); Abhradeep Sengupta, Bengaluru (IN); Yakov Goyhman, Dubai (AE); Anshuman Kanwar, Cambridge, MA (US)

(21) Appl. No.: 19/540,403

(22) Filed: Feb. 13, 2026

Related U.S. Application Data
(60) Provisional application No. 63/758,285, filed on Feb. 13, 2025.

(51) Int. Cl. G06F 21/62; G06F 21/60

(52) U.S. Cl. CPC G06F 21/6254; G06F 21/604

(57) ABSTRACT

Storing a plurality of datasets including personally identifiable information (PII). Establishing a secure API layer that is an enforcement point for masking the PII. Defining masking criteria that considers a structure of the PII, wherein the masking criteria is defined based on regular expressions. Masking, at an API level, attributes of the PII based on the masking criteria, thereby preventing users from searching the masked data. Presenting the masked attributes to a user via the secure API layer. Securely unmasking at least a portion of the masked attributes using unique API calls based on user-level permissions associated with the user. Presenting the unmasked attributes via the secure API layer. Centrally logging the masking of the attributes of the PII and the unmasking of the at least a portion of the masked attributes. Generating, by the API-centric dynamic masking system, an audit trail based on the centrally logged information.

### CROSS-REFERENCE TO RELATED APPLICATIONS

The current application claims priority to U.S. Provisional Patent Application Ser. No. 63/758,285 filed Feb. 13, 2025, which is incorporated by reference herein.

### BRIEF DESCRIPTION OF THE DRAWINGS

FIG. 1 depicts a diagram of an example connected data platform.

FIG. 2 depicts a diagram of an example environment for an integration hub system.

FIG. 3 depicts a diagram of an example three-layer model.

FIG. 4 depicts a diagram of some examples of entity type, relationship type, and event metadata.

FIG. 5 depicts a flowchart of an example of a method of dynamic matching facilitation.

FIG. 6 depicts a diagram of an example environment for API-centric masking with dynamic user-level control.

FIG. 7 depicts a diagram of an example API-centric dynamic masking system.

FIG. 8 depicts a flowchart of an example method of API-centric masking with dynamic user-level control.

FIG. 9 depicts a flowchart of an example method of API-centric masking with dynamic user-level control.

FIG. 10 depicts a flowchart of an example method of API-centric masking with dynamic user-level control.

FIG. 11 depicts a dynamic matching flowchart.

FIG. 12 depicts a high-level flowchart for MatchIQ.

FIG. 13 depicts a flowchart for configuring survivorship within an example User Interface (UI).

FIG. 14 depicts a flowchart of an example of a method of cross-tenant matching and lineage EID promotion.

FIG. 15 depicts a flowchart of an example of a method of cross-tenant matching and lineage EID promotion.

### DETAILED DESCRIPTION

A claimed solution rooted in computer technology overcomes problems specifically arising in the realm of computer technology. In various embodiments, a computing system (e.g., an API-centric dynamic masking system and/or multi-tenant platform) is configured to establish a secure application programming interface (API) layer as an enforcement point for masking data (e.g., personally identifiable information) at the API-level, as opposed to the user interface-level or database-level. More specifically, the computing system can provide a dynamically adaptable, role-based masking system with detailed metadata security, allowing for fine-grained control over data access. The computing system can enable a backward-compatible architecture for phased rollout of masking capabilities without disrupting existing services and integrations. In one example, the computing system can use regular expressions to define masking criteria that considers the structure of the data and provides a flexible approach. The computing system can further allow users to view masked attributes in the user interface, while also providing a secure method of unmasking the attributes if needed using unique API calls based on user-level permissions. The computing system can additionally provide a central logging system for unmasking actions, ensuring accountability and auditability of all masking actions. The computing system can also prevent users from searching on data that is sensitive by masking the data in the search.

By providing these and other features, the computing system solves a variety of technical problems, such as insecure data exposure, static access control, fragmented security posture, rigid data handling, and lack of audit trails. More specifically, the computing system can prevent potential breaches by masking data at the API-level before it is even rendered in the user interface. The computing system can also avoid the limitations of static access control by providing user and role-based, real-time access checks. The computing system can also provide a centralized approach to data masking across the multi-tenant platform and/or associated systems, thereby creating a consistent security approach. The computing system can also provide a flexible solution for handling data with dynamic permissions and an on-demand unmasking process. The computing system can also provide a clear and auditable mechanism for viewing masking settings and activities.

Accordingly, the computing system provides many advantages over traditional solutions. For example, the computing system can provide API-level centralized masking enforcement, dynamic and contextual masking, phased implementation, secure and granular unmasking, and a unified user experience. For example, the computing system can provide a unified master data management (MDM) platform that conditionally masks sensitive attribute values based on user role permissions, with support for partial and/or custom mask patterns, while still allowing the unmasked values to be used internally for data matching and other processing (e.g., entity resolution). Accordingly, the computing system provides a technical solution to a technical problem. More specifically, the technical problem is how to preserve entity resolution functionality using sensitive values while minimizing and/or preventing sensitive data exposure, and the computing system provides the technical solution using dynamic conditional masking.

In various embodiments, a computing system is configured to identify matching data records within a set of data records and merge the matching data records. The computing system can identify attributes in a data model using the entity resolution request. The computing system can then identify other attributes in the data model and/or other data models.

In various embodiments, a unique architecture enables efficient modeling of entities, relationships, and interactions that typically form the basis of a business. These models enable insights, scalability, and management not previously available in the prior art. It will be appreciated that with the information model discussed herein, there is no need to consider tables, foreign keys, or any of the low-level physicality of how the data is stored.

An information model may be utilized as a part of a multi-tenant platform. In a specific implementation, a configuration sits in a layer on top of the RELTIO™ platform and natively enjoys capabilities provided by the platform such as matching, merging, cleansing, standardization, workflow, and so on. Entities established in a tenant may be associated with custom and/or standard interactions of the platform. The ability to hold and link three kinds of data (i.e., entities, relationships, and interactions) in the platform and leverage the confluence of them in one place provides unlimited power to model and understanding to a business.

In various embodiments, the metadata configuration is based on an n-layer model. One example is a 3-layer model (e.g., which is the default arrangement). In some embodiments, each layer is represented by a JSON file (although it will be appreciated that many different file structures may be utilized such as BSON or YAML).

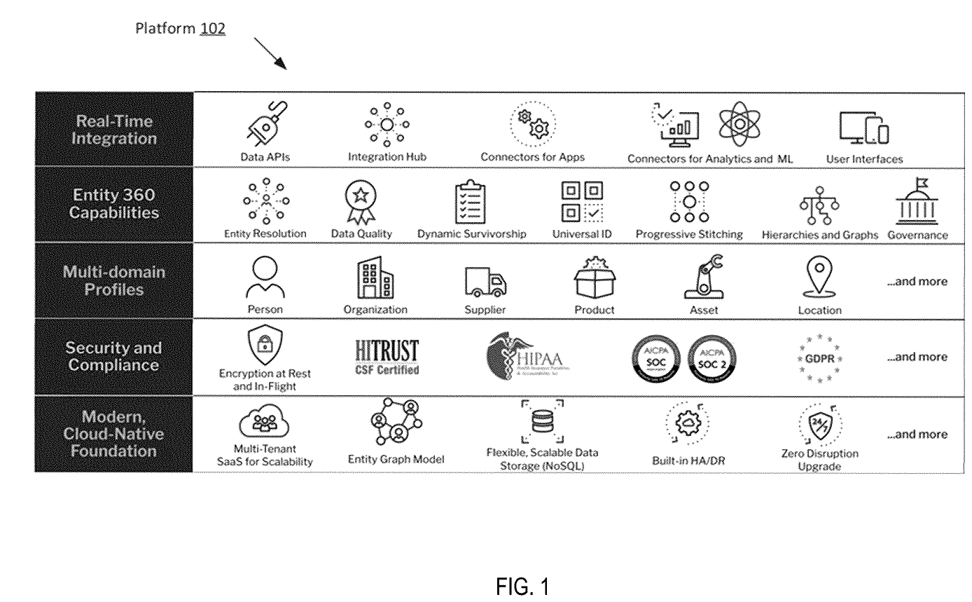

The information models may be utilized as a part of a connected, multi-tenant system. FIG. 1 depicts a platform 102. The platform 102 enables seamless scaling in many operational or analytical use case. The platform 102 may be the foundation of master data management (MDM). Various integration options, including a low-code/no-code solution, allow rapid deployment and time to value.

FIG. 1 is an example of functions of the platform 102 in some embodiments. The platform 102 may support best in class MDM capabilities, including identity resolution, data quality, dynamic survivorship for contextual profiles, universal ID across all your operational applications and hierarchies, knowledge graph to manage relationships, progressive stitching to create richer profiles, and governance capabilities. Further, the platform 102 may support high volume transactions, high volume API calls, sophisticated analytics, and back-end jobs for any workload in an auto-scaling cloud environment. As follows, the platform 102 may support high redundancy, fault tolerance, and availability with built-in NoSQL database, Elasticsearch, Spark, and other AWS and GCP services across multiple zones.

In various embodiments, the platform 102 is multi-domain and enables seamless integration of many types of data and from many sources to create master profiles of any data entity—person, organization, product, location. Users can create master profiles for consumers, B2B customers, products, assets, sites, and connect them to see the complete picture.

The platform 102 may enable API-first approach to data integration and orchestration. Users (e.g., tenants) can use APIs, and various application-specific connectors to ease integration. Additionally, in some embodiments, users can stream data to analytics or data science platforms for immediate insights.

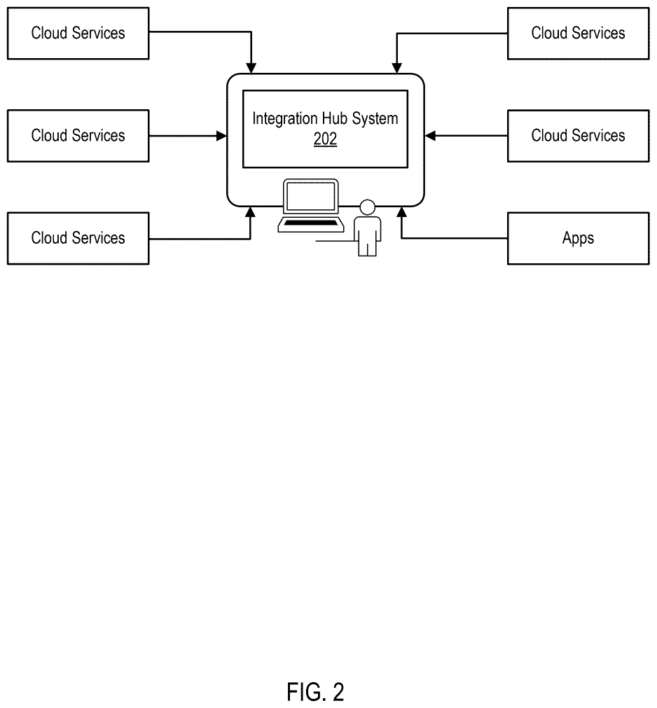

FIG. 2 depicts an environment for an integration hub system 202. The integration hub system 202 may connect various data sources and downstream consumers. In some embodiments, the integration hub system 202 comes with over 1,000 connectors to build data pipelines right. The integration hub system 202 may include an intuitive drag-and-drop graphical interface to create simple replication pipelines to complex data extraction and transformation tasks. With pre-built community recipes for common use cases, users can set up integration workflows in just a few clicks.

Along with the built-in data loader, event streaming capabilities, data APIs, and partner connectors, the integration hub system 202 enables rapid links to user systems using the platform 102. The integration hub system 202 may enable users to build automated workflows to get data to and from the platform 102 with any number of SaaS applications in just hours or days. Faster integration enables faster access to unified, trusted data to drive real-time business operations.

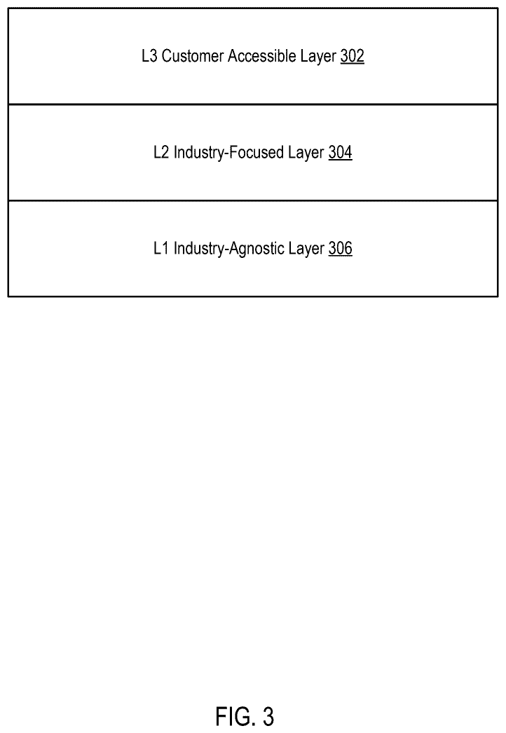

FIG. 3 depicts a three-layer model in some embodiments. Of the three layers, only layer 3 (e.g., the top layer of the n-layer model) 302, known as the “L3” is accessible by the customer. It is the layer that is a part of a tenant. The information associated with the L3 layer 302 may be retrieved from the tenant, edited. and applied back to the tenant using Configuration API.

The L3 302 layer typically inherits from the L2 layer 304 (an industry-focused layer) which in turn inherits from the L1 layer 306 (An industry-agnostic layer). Usually, the L3 layer 302 refers to an L2 304 container and inherits all data items (or “objects”) from the L2 304 container. However, it is not required that the L3 302 refer to the L2 304 container, it can standalone.

The L2 layer 304 may inherit the objects from the L1 layer. Whereas there is only a single L1 306 set of objects, the objects at the L2 layer 304 may be grouped into industry-specific containers. Like the L1 layer 306, the containers at the L2 layer 304 may be controlled by product management and may not be accessible by customers.

Life sciences is a good example of an L2 layer 304 container. The L2 layer 304 container 304 may inherit the Organization entity type (discussed further herein) from L1 layer 306 and extends it to the Health Care Organization (HCO) type needed in life sciences. As such, the HCO type enjoys all of the attribution and other properties of the Organization type, but defines additional attributes and properties needed by an HCO.

The L1 layer 306 may contain entities such as Party (an abstract type) and Location. In some embodiments, the L1 layer 306 contains a fundamental relationship type called HasAddress that links the Party type to the Location type. The L1 layer 306 also extends the Party type to Organization and Individual (both are non-abstract types).

There may be only one L1 layer 306, and its role is to define industry-agnostic objects that can be inherited and utilized by industry specific layers that sit at the L2 layer 304. This enables enhancement of the objects in the L1 layer 306, potentially affecting all customers. For example, if an additional attribute was added into the HasAddress relationship type, it typically would be available for immediate use by any customer of the platform.

Any object can be defined in any layer. It is the consolidated configuration resulting from the inheritance between the three layers that is commonly referred to as the tenant configuration or metadata configuration. In a specific implementation, metadata configuration consolidates simple, nested, and reference attributes from all the related layers. Values described in the higher layer overrides the values from the lower layers. The number of layers does not affect the inheritance.

In a specific implementation, metadata configuration consolidates simple, nested, and reference attributes from all the related layers. Values described in the higher layer overrides the values from the lower layers. The number of layers does not affect the inheritance.

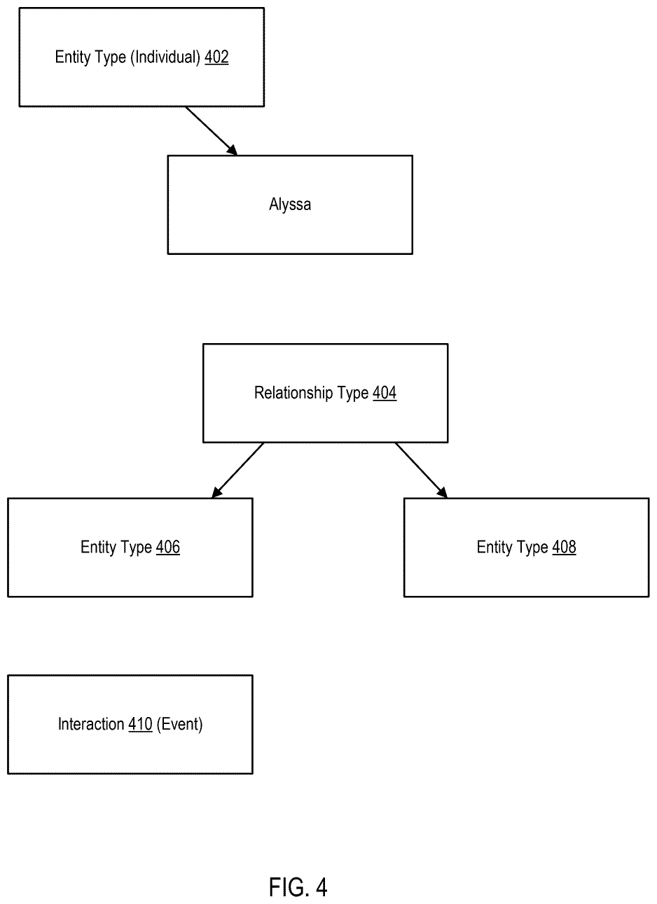

FIG. 4 is a box diagram of some examples of entity type, relationship type and event metadata. The platform 102 enables object types entities, relationships, and interactions. The entity type 402 may be a class of entity. For example, “Individual” is an entity type 402, and “Alyssa” represents a specific instance of that entity type. Other common examples of entity types include “Organization,” “Location,” and “Product.”

Often, entity types can materialize in single instances, such as the “Alyssa” example above. In another example, the L1 layer may define the abstract “Party” entity type with a small collection of attributes. The L1 layer may then be configured to define the “Individual” entity type and the “Organization” entity type, both of which inherit from “Party,” both of which are non-abstract and both of which add additional attributes specific to their type and business function. Continuing with the concept of inheritance, in the L2 Life Sciences container, the HCP entity may be defined (to represent physicians) which inherits from the “Individual” type but also defines a small collection of attributes unique to the HCP concept. Thus, there is an entity taxonomy “Party,” “Individual,” or “HCP,” and the resulting HCP entity type provides the developer and user with the aggregate attribution of “Party,” “Individual,” and “HCP.”

Once the entity types are defined, the user can link entities together in a data model by using the relationship type. Once the user defines entity types, they can be linked by defining relationships between them. For example, a user can post a relationship independently to link two entities together, or the client can mention a relationship in a JSON, which then posts the relationship and the two entities all at once.

A relationship type 404 describes the links or connections between two specific entities (e.g., entities 406 and 408). A relationship type 404 and the entities 406 and 408 described together form a graph. Some common relationship types are Organization to Organization, Subsidiary Of, Partner Of, Individual to Individual, Parent of/Child Of, Reports To, Individual to Organization/Organization to Individual, Affiliated With, Employee Of/Contractor Of.

Once the user defines entity types, they can be linked by defining relationships between them. For example, a user can post a relationship independently to link two entities together, or the client can mention a relationship in a JSON, which then posts the relationship and the two entities all at once.

The platform 102 may enable the user to define metadata properties and attributes for relationship types. The user can define up to any number metadata properties. The user can also define several attributes for a relationship type, such as name, description, direction (undirected, directed, bi-directional), start and end entities, and more. Attributes of one relationship type can inherit attributes from other relationship types.

Hierarchies may be defined through the definition of relationship subtypes. For example, if a user defines “Family” as a relationship type, the user can define “Parent” as a subtype. One hierarchy contains one or many relationship types; all the entities connected by these relationships form a hierarchy. Entity A>HasChild (Entity B)>HasChild (Entity C). Then A, B, and C form a hierarchy. In the same hierarchy, the user can add Subsidiary as a relationship and if Entity D is subsidiary of Entity C, then A, B, C, and D all become part of a single hierarchy.

Interactions 410 are lightweight objects that represent any kind of interaction or transaction. As a broad term, interaction 410 stands for an event that occurs at a particular moment such as a retail purchase or a measurement. It can also represent a fact in a period of time such as a sales figure for the month of June.

Interactions 410 may have multiple actors (entities), and can have varying record lengths, columns, and formats. The data model may be defined using attribute types. As a result, the user can build a logical data model rather than relying on physical tables and foreign keys; define entities, relationships, and interactions in granular detail; make detailed data available to content and interaction designers; provide business users with rich, yet streamlined, search and navigation experiences.

In various embodiments, four manifestations of the attribute type include Simple, Nested, Reference, and Analytic. The simple attribute type represents a single characteristic of an entity, relationship, or interaction. The nested, reference and analytic attribute types represent combinations or collections of simple sub-attribute types.

The nested attribute type is used to create collections of simple attributes. For example, a phone number is a nested attribute. The sub-attributes of a phone number typically include Number, Type, Area code, Extension. In the example of a phone number, the sub-attributes are only meaningful when held together as a collection. When posted as a nested attribute, the entire collection represents a single instance, or value, of the nested attribute. Posts of additional collections are also valid and serve to accumulate additional nested attributes within the entity, relationship or interaction data type.

The reference attribute type facilitates easy definition of relationships between entity types in a data model.

A user may utilize the reference attribute type when they need one entity to make use of the attributes of another entity without natively defining the attributes of both. For example, the L1 layer in the information model defines a relationship that links an Organization and an Individual using the affiliated with relationship type. The affiliated with relationship type defines the Organization entity type to be a reference attribute of the Individual entity type. This approach to data modeling enables easier navigation between entities and easier refined search.

Easier navigation between entities: In the example of the Organization and Individual entities that are related using the affiliated with relationship type, specifying an attribute of previous employer for the Individual entity type enables this attribute to be presented as a hyperlink on the individual's profile facet. From there, the user can navigate easily to the individual's previous employer.

Easily refined search: When attributes of a referenced entity and relationship type are available to be indexed as though they were native to the referencing entity, business users can more easily refine search queries. For example, in a search of a data set that contains 100 John Smith records, entering John Smith in the search box will return 100 John Smith records. Adding Acme to the search criteria will return only those records with John Smith that have a reference, and thus an attribute, that contains the word Acme.

The analytic attribute type is lightweight. In various embodiments, it is not managed in the same way that other attributes are managed when records come together during a merge operation. The analytic attribute type may be used to receive and hold values delivered by an analytics solution.

The user may utilize the analytic attribute type when they want to make a value from your analytics solution, such as Reltio Insights, available to a business user or to other applications using the Reltio Rest API. For example, if an analytics implementation calculates a customer's lifetime value and the user needs that value to be available to the user while they are looking at the customer's profile, the user may define an analytic attribute to hold this value and provide instructions to deliver the result of the calculation to this attribute.

In a specific implementation, the platform 102 assigns entity IDs (EIDs) to each item of data that enters the platform. As such, the platform can appropriately be characterized as including an EID assignment engine. Importantly, a lineage-persistent relational database management system (RDBMS) retains the EIDs for each piece of data, even if the data is merged and/or assigned a new EID. As such, the platform can appropriately be characterized as including a legacy EID retention engine, which has the task of ensuring when new EIDs are assigned, legacy EIDs are retained in a legacy EID datastore. The legacy EID retention engine can at least conceptually be divided into a legacy EID survivorship subengine responsible for retaining all EIDs that are not promoted to primary EID as legacy EIDs and a lineage EID promotion subengine responsible for promoting an EID of a first data item merged with a second data item to primary EID of the merged data item. An engine responsible for changing data items, including merging and unmerging (previously merged) data items can be characterized as a data item update engine. Cross-tenant durability also becomes possible when legacy EIDs are retained. In a specific implementation, a cross-tenant durable EID lineage-persistent RDBMS has an n-Layer architecture, such as a 3-Layer architecture.

Data may come from multiple sources. The process of receiving data items can be referred to as “onboarding” and, as such, the platform 102 can be characterized as including a new dataset onboarding engine. Each data source is registered and, in a specific implementation, all data that is ultimately loaded into a tenant will be associated with a data source. If no source is specified when creating a data item (or “object”), the source may have a default value. As such, the platform can be characterized as including an object registration engine that registers data items in association with their source.

A crosswalk can represent a data provider or a non-data provider. Data providers supply attribute values for an object and the attributes are associated with the crosswalk. Non-data providers are associated with an overall entity (or relationship); it may be used to link an L1 (or L2) object with an object in another system. Crosswalks do not necessarily just apply to the entity level; each supplied attribute can be associated with data provider crosswalks. Crosswalks are analogous to the Primary Key or Unique Identifier in the RDBMS industry.

The engines and datastores of the platform 102 can be connected using a computer-readable medium (CRM). A CRM is intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g., “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof, 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented as cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations, while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

Matching is a powerful area of functionality and can be leveraged in various ways to support different needs. The classic scenario is that of matching and merging entities (Profiles). Within the architecture discussed herein, relationships that link entities can also and often do match and merge into a single relationship. This may occur automatically and is discussed herein.

Matching can be used on profiles within a tenant to deduplicate them. It can be used externally from the tenant on records in a file to identify records within that file that match to profiles within a tenant. Matching may also be used to match profiles stored within a Data Tenant to those within a tenant.

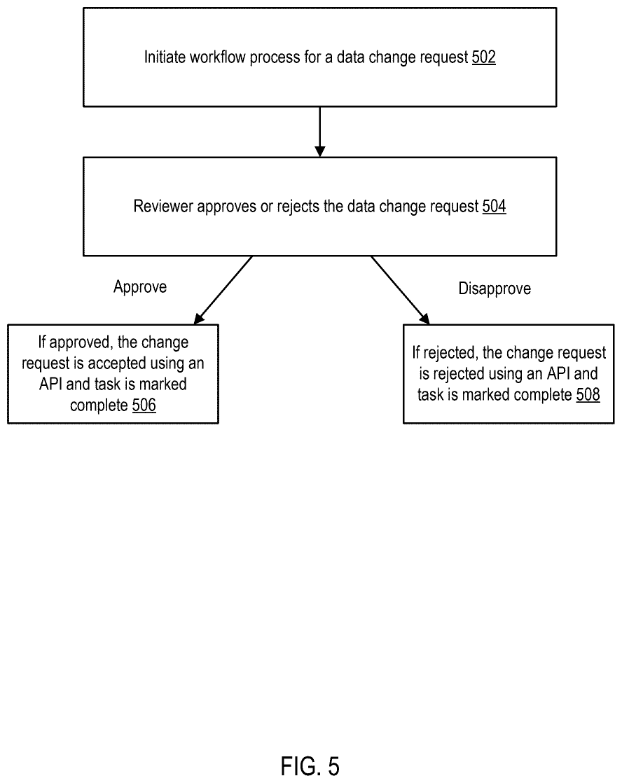

FIG. 5 depicts a flowchart of an example of a method of a dynamic matching facilitation. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In some embodiments, a workflow is a series of sequential steps or tasks that are carried out based on user-defined rules or conditions to execute a business process. The Workflow may allow a user to manage complex business processes through a series of predetermined steps or tasks. The platform 102 may utilize the workflow to enable processes and tasks management, including the assignment and tracking of the tasks. A workflow process may support a creator, a create date, a due date, an assignee, steps, and comments. In various embodiments, workflow business processes are configurable. In some embodiments, the various actors and triggers in a workflow are Actors: The people and processes that participate in the workflow are the actors, e.g., Reviewer, Workflow Engine, Hub, and API; Reviewer: The user will be assigned with the role ROLE_REVIEWER; Trigger: It is a scheduled process that scans activity logs to initiate a review workflow, e.g., from the UI, you can start a Data Change Request (DCR) workflow to review the updates or the changes to the entities or the profiles data in your tenant. The workflow feature may allow a user to manage business processes through a series of predetermined steps or tasks which enables you to plan and coordinate user tasks, validations, reviews, and approvals for multiple records.

Data Change Request (DCR) is a collection of suggested data changes. Users who do not have rights to update objects, such as the customer sales representatives, can suggest changes. These suggested changes will be accumulated in Data Change Requests queued for review and approval by people with approval privileges, such as the data stewards. Examples of suggested data changes include adding a new attribute value, updating an attribute value, deleting an attribute value, and creating a new object along with referenced objects. Data Change Requests can be initiated using web browser-based user interface for Desktop or Mobile. An example of a step can be a user task assigned to users for Review and Approval of the data change request. In this example, a Workflow for a Data Change Request (DCR) includes the following sequence of steps in the flowchart of FIG. 5.

In module 502, on the profile page in Hub, users can initiate the DCR workflow process in the Suggesting mode.

In module 504, the Reviewer can Approve or Reject the DCR. In the Data Change Request Review pane of the UI, sub-attributes within the nested, reference, or complex attributes, and parent-nested attributes, have a label of the attribute value.

In module 506, if the Reviewer approves the DCR, the change request is accepted using the API and the task is marked complete.

In alternative module 508, if the Reviewer rejects the DCR, the change request is rejected using the API and the task is marked complete. In the Inbox, you have the option of partially rejecting changes from a DCR. In various embodiments, a reviewer may selectively reject attributes and approve a DCR partially.

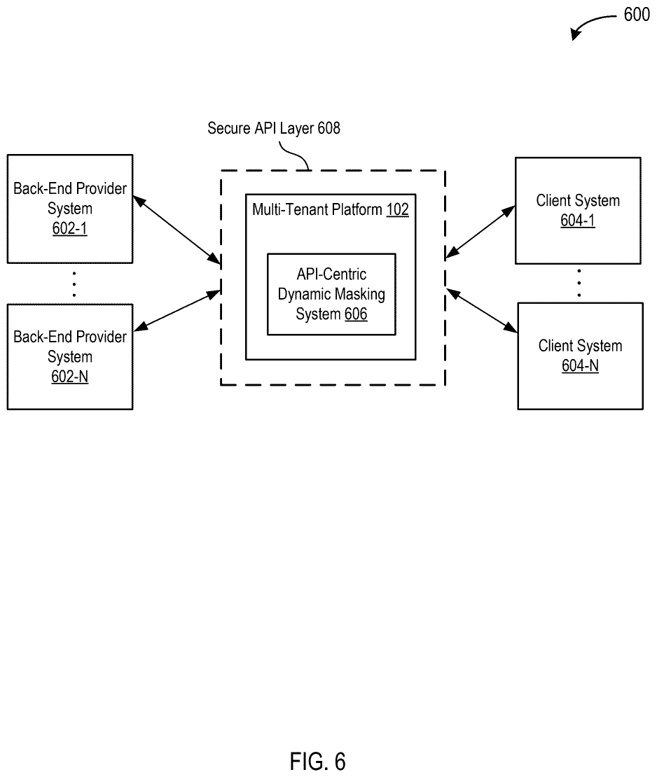

FIG. 6 depicts a diagram of an example environment 600 for API-centric masking with dynamic user-level control. In the example of FIG. 6, the network environment 600 includes a multi-tenant platform 102 (or, simply, platform 102), back-end provider systems 602-1 to 602-N (individually, the back-end provider system 602, collectively, the back-end provider systems 602), client systems 604-1 to 604-N (individually, the client system 604, collectively, the client systems 604), an API-centric dynamic masking system 602, and a secure API layer 608.

In the example of FIG. 6, the multi-tenant platform 102 is a multi-domain and/or multi-tenant computing platform that enables seamless integration of many types of data from many sources. The platform 102 may include a variety of different data structures having different formats, structures, data, and/or the like. The multi-tenant platform 102 may include some or all functionality and components as the platform 102 described elsewhere herein.

In some embodiments, the multi-tenant platform 102 efficiently provides secure data management without unnecessarily exposing sensitive data. More specifically, the multi-tenant platform 102 can use the secure API layer 608 and data management operation metadata to operate on data in the cloud environment of the platform 102 without exposing sensitive data outside the platform 102.

In the example of FIG. 6, the back-end provider systems 602 include different back-end service provider systems. The back-end provider systems can include cloud-native service providers (e.g., AWS, Azure), hosted-service providers, and the like. The back-end service provider systems 602 can provide storage services and/or other back-end services for the multi-tenant platform 102 and the clients (e.g., tenants) thereof.

In the example of FIG. 6, the client systems 604 include clients of the multi-tenant platform 102. The client systems 604 may be clients of the multi-tenant platform 102 and may be associated with one or more tenants and/or domains of the multi-tenant platform 102.

In the example of FIG. 6, the platform 102 includes the API-centric dynamic masking system 606. It will be appreciated that in some embodiments the API-centric dynamic masking system 606 may be distinct from the platform 102 and may communicate with the platform 102 (e.g., over a communications network).

The API-centric dynamic masking system 606 can establish (e.g., instantiate) a secure API layer 608 as the enforcement point for masking data (e.g., personally identifiable information (PII)), moving past simple UI or database-level approaches. The API-centric dynamic masking system 606 can provide a dynamically adaptable, role-based masking system with detailed metadata security, allowing for fine-grained control over data access. The API-centric dynamic masking system 606 can enable a backward-compatible architecture for phased rollout of masking capabilities without disrupting existing services and integrations. The API-centric dynamic masking system 606 can use regular expressions to define masking criteria that considers the structure of the data and provides a flexible approach. The API-centric dynamic masking system 606 can allow users to view masked attributes in the user interface, while also providing a secure method of unmasking the attributes if needed using unique API calls based on user-level permissions. The API-centric dynamic masking system 606 can provide a central logging system for unmasking actions, ensuring accountability and auditability of all masking actions. The API-centric dynamic masking system 606 can also prevent users from searching on data that is sensitive by masking the data in search.

By providing these and other features, the API-centric dynamic masking system 606 solves a variety of technical problems, such as insecure data exposure, static access control, fragmented security posture, rigid data handling, and lack of audit trails. More specifically, the API-centric dynamic masking system 606 can prevent potential breaches by masking PI at the API level before it is even rendered in the user interface. The API-centric dynamic masking system 606 can also avoid the limitations of static access control by providing user and role-based, real-time access checks. The API-centric dynamic masking system 606 can also provide a centralized approach to data masking across all the platform 102 and/or associated systems (e.g., back-end provider system 602), thereby creating a consistent security approach. The API-centric dynamic masking system 606 can also provide a flexible solution for handling PII with dynamic permissions and an on-demand unmasking process. The API-centric dynamic masking system 606 can also provide a clear and auditable mechanism for viewing masking settings and activities.

Accordingly, the API-centric dynamic masking system 606 provides many advantages over traditional solutions. For example:
API-level centralized masking enforcement: Unlike client-side masking or database-level masking, this architecture shifts the burden of security to a core API gateway, minimizing reliance on UI or database implementations.
Dynamic & contextual masking: The real-time permission checking and metadata-based system allows for a much more contextual and flexible approach to masking.
Phased implementation: Existing integrations continue to work, allowing for a phased implementation of the masking feature.
Granular unmasking: The specific user-level permissions and attribute based API calls for unmasking ensure that only authorized users have access to specific PII at specific times, optimizing security while maintaining functionality.
Unified user experience: Regardless of user interface, masking and unmasking behaviors remain consistent across the platform.

In some embodiments, the API-centric dynamic masking system 606 can include masking strategies (e.g., in addition to API-level masking) such as anonymization and/or tokenization.

In some embodiments, features of the API-centric dynamic masking system 606 can be incorporated into (1) all core interfaces and features, ranging from individual entity profiles view to other areas of the platform 102, such as export, search and reporting, now implement the API-centric data masking functionality; (2) all areas in the platform 102 that deal with PII, including Profile, Inbox, DCR, Activity Logs, Potential Matches, and History, now include the masked UI elements and masking functionality; and (3) the API's are also used within the search functionality, and the export functionality to be compliant with the masking protocols.

The API-centric dynamic masking system 606 can provide technical benefits to variety of different types of organizations (e.g., enterprises), users, customers, and/or the like. For example, organizations with stringent data governance and privacy requirements will use it to protect sensitive information; application developers building platform 102 based integrations can leverage the masking API, and organizations requiring auditable user access control can utilize the masking and logging functionality for data compliance.

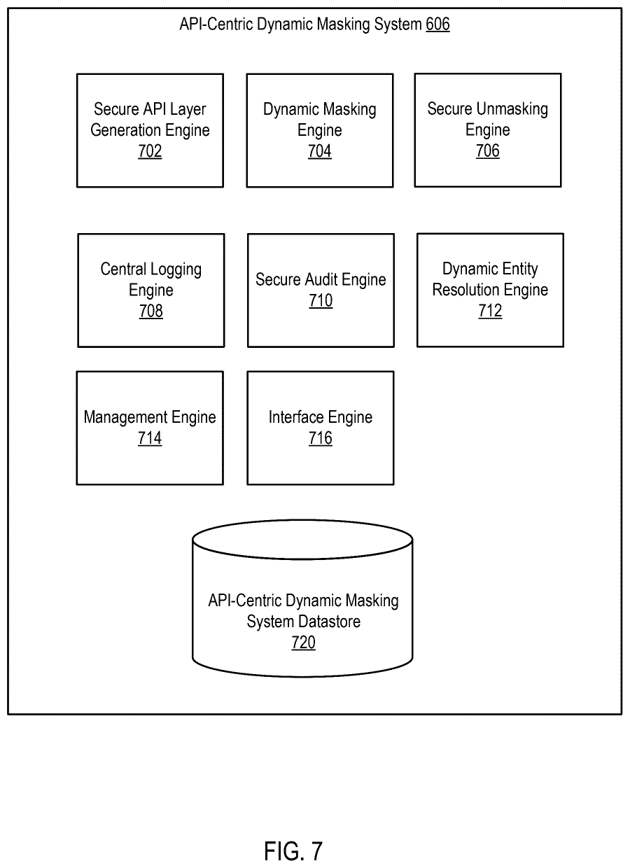

FIG. 7 depicts a diagram of an example API-centric dynamic masking system 606. In the example of FIG. 7, the API-centric dynamic masking system 606 includes a secure API layer generation engine 702, a dynamic masking engine 704, a secure unmasking engine 706, a central logging engine 708, a secure audit engine 710, a dynamic entity resolution engine 712, a management engine 714, an interface engine 716, and an API-centric dynamic masking system datastore 720 (or, “MDM datastore”).

The secure API layer generation engine 702 is intended to represent an engine that can manage and/or establish a secure API layer. In some embodiments, masking is implemented at the by the secure API layer. According, some or all mechanisms of data access can consistently apply the masking rules. For example, the API-centric dynamic masking system 606 can intercept outgoing data and replace and/or obfuscate masked fields as necessary before delivering the response. By doing this in the central secure API layer, the API-centric dynamic masking system 606 ensures there are no “back doors” where sensitive data could be retrieved unmasked without authorization. The actual stored data (e.g., stored in datastore 720) remains unchanged (e.g., in its true form) but is only revealed to authorized requests.

The dynamic masking engine 704 is intended to represent an engine that can intelligently and securely mask data at the API-level (and/or API-layer). More specifically, the dynamic masking engine 704 can define masking criteria that considers the structure of the data. The masking criteria can be defined based on regular expressions and/or contextual information (e.g., user-roles, user permissions, audit histories, etc.). The dynamic masking engine 704 can mask attributes of the data based on the masking criteria, thereby preventing users from searching the masked data. In some embodiments, the dynamic masking engine masks the attributes (or, “actual values”).

In some embodiments, the dynamic masking engine 704 function to protect sensitive information, such PII and SPII (sensitive personal information) by masking certain data fields across all access points (UI, APIs, and exports). As used herein, reference to PII or personally identifiable information can refer to personally identifiable information and/or sensitive personable identifiable information. The dynamic masking engine 704 can facilitate the enforcement of data privacy and compliance (e.g., GDPR, CCPA, HIPAA) while maintaining the usability of the data for legitimate processing (e.g., entity resolution) within the platform 102.

In some embodiments, the dynamic masking engine 704 provides attribute-level masking rules. For example, administrators can designate specific attributes (e.g., fields) in the data model as “masked.” Once enabled, the attribute can be treated as sensitive PII. Masking can be configured at a granular level (e.g., per attribute) rather than an all-or-nothing approach.

In some embodiments, the dynamic masking engine 704 provides configurable (or, “custom”) masking patterns. The dynamic masking engine 704 can provide multiple masking options for how data will be masked (e.g., obfuscated) when presented to unauthorized viewers. Administrators can choose among several built-in patterns or define custom ones, such as full mask (e.g., mask the entire value, such as by replacing all characters with **** or an opaque token), email mask (e.g., reveal only the email domain while masking the user part, such as ****@domain.com), last N characters masked (e.g., reveal all but the last N characters which can be useful for showing only last 4 digits of SSN, and/or the like),first N characters masked (e.g., reveal only the first N characters, and masking the rest), and/or custom mask (pattern expression). Custom masks can define a tailored masking pattern using a masking expression (e.g., regular expressions and/or regular expression-based rules). This can allow flexible formats (e.g., showing only partial segments of an ID or credit card number with fixed placeholders in other positions).

The ability of the dynamic masking engine 704 to define partial and custom masks means masked data can retain some of its format or informational value (e.g., showing data length or a portion of the value) while still hiding the sensitive parts.

In some embodiments, the dynamic masking engine 704 provides granular masking rules with partial revelation. For example, traditional systems approached data hiding as a binary all-or-nothing (e.g., show or hide field) based on permissions. The API-centric dynamic masking system 606, and dynamic masking engine 704 more specifically, by contrast, allows partial revelation of data via configurable patterns. This is more sophisticated and user-friendly (e.g., showing the last 4 digits of a national ID allows authorized users to confirm two records refer to the same person without seeing the full ID. The “masking expressions” capability for custom patterns is particularly powerful, as it can enforce organization-specific masking formats (e.g., by replacing all but the first letter of a last name with x's, or masking a credit card number except for the BIN and last 4 digits).

In some embodiments, the dynamic masking engine 704 utilizes role-based access control (RBAC) to control who can see the real (or, “actual”) sensitive data. Only users with appropriate roles/permissions can “unmask” and view the actual sensitive value. By default, if RBAC is not configured for the mask feature, everyone can see the actual data, but once RBAC rules are in place, only authorized roles can view unmasked values. For example, a user without unmask privileges would see a masked placeholders and would need to have permission to reveal the data. This can ensure that sensitive PII is only visible to those who truly need it. Particular types of users (e.g., administrators) can configure which attributes are masked and which roles are allowed to view them unmasked. For example, a Data Steward role might have permission to see a customer's full Social Security number, whereas a general business user sees only a masked version.

By implementing these masking controls, organizations can more easily comply with data privacy laws and policies. The dynamic masking engine 704 reduces the risk of unauthorized or inadvertent exposure of PII, since even if data is accessed by an unauthorized person, the critical details are obfuscated. Masking also helps in creating de-identified views of data for analytics or sharing. For example, a dataset can be exported with identifiers masked so that it is no longer considered “personal data” under regulations, yet still useful for statistical analysis. In some embodiments, dynamic data masking can be a proactive measure to reduce the risk of unauthorized and unnecessary access to personally identifiable data while ensuring compliance with data privacy regulations.

In some embodiments, the dynamic masking engine 704 integrates RBAC and tenant configuration. More specifically, permissions to unmask data and/or mask data can be granted or revoked per role, and these can be different for different tenants of the multi-tenant platform 102. For example, a System Administrator might have an “Unmask All PII” privilege, whereas a Business Analyst role may have none. This may be implemented using new access control metadata (e.g., a flag in role definitions or a new permission type) to ensure that all relevant application components respect it. In the multi-tenant platform 102, the configuration for which attributes are masked and which roles can see them can be specific to each tenant (e.g., each tenant's data model and/or security policy). Accordingly, each tenant can configure their own masking rules and role permissions without coding (e.g., a dynamic configuration-driven approach) via a GUI.

In some embodiments, the dynamic masking engine 704 provides dynamic, on-the-fly masking. More specifically, rather than physically encrypting or removing data at rest, the dynamic masking engine 704 can mask data dynamically when it is retrieved. This dynamic masking can be implemented by the dynamic masking engine 704 in the application/API layer (e.g., secure API layer 608). For example, when a user or system requests an entity's data, the dynamic masking engine 704 can check the attribute definitions and the requester's roles, and then dynamically substitutes the output for masked fields if needed. Accordingly, the underlying datastore 720 can still contain the true (or, actual) values (allowing internal entity resolution operations to use them), but the output is sanitized. Accordingly, the dynamic masking disclosed herein extends traditional masking within a multi-tenant MDM platform with complex data relationships. This can ensure consistency across channels through a single masking service, which can improve security (e.g., one central control point).

In some embodiments, the dynamic masking engine 704 can preserve data unification capabilities. As discussed elsewhere herein, one of the technical problems solved by the systems and engines described herein is how to allow masked data to still participate in entity resolution (e.g., matching and merging). Typically, if data is encrypted or hashed for privacy, it becomes difficult to use for fuzzy matching or linking records. Instead, the dynamic masking engine 704 can mark attributes as masked for display, but internally the dynamic entity resolution engine 712 sees the actual values. Accordingly, the dynamic masking engine 704 can partition who or what in the multi-tenant platform 102 can access the clear values. For example, the dynamic entity resolution engine 712 can run with system-level privileges and are not subject to user-level masking restrictions. Thus, it can compare SSNs or phone numbers across records to compute match scores, even if those fields would be hidden from normal view. This is an improvement over traditional systems which used full anonymization (e.g., tokenizing or removing PII entirely), which can cripple an MDM system's ability to identify duplicates since the traditional system cannot match what they cannot see.

The secure unmasking engine 706 is intended to represent an engine that can securely unmask at least a portion of masked attributes using unique API calls based on user-level and/or role-based permissions. The unmasking can be performed in real-time and/or on demand. Likewise, some or all of the other operations performed herein (e.g., masking) can be performed in real-time and/or on-demand.

In some embodiments, the secure unmasking engine 706 can disclose (and/or allow the disclosure) of actual values underlying masked values in response to determining that a requesting user is authorized to view the sensitive attribute's actual value (e.g., based on RBAC). In some embodiments, a secure unmasking engine (e.g., secure unmasking engine) discloses the actual value, which can be provided to other entities by the interface engine.

The central logging engine 708 is intended to represent an engine that can log masking and unmasking operations. In some embodiments, this central logging engine 708 can log operations locally (e.g., in datastore 720) and/or remotely. Operations can be logged so that they can be searched (e.g., by keyword, date/time, metadata tags, regular expressions, and/or the like). Logged operations can be associated with a user (e.g., a user associated with a masking or unmasking operation). This central logging engine 708 can, for example, ensure accountability and auditability of all masking actions.

The secure audit engine 710 is intended to represent an engine that can generate an audit trail based on the centrally logged information. For example, it can retrieve logs generated by the central logging engine 708 to generate an audit trail on demand, periodically, manually, and/or automatically.

The dynamic entity resolution engine 712 is intended to represent an engine that can execute a variety of data management and entity resolution operations, such as matching (e.g., rules-based matching and/or machine learning-based matching) records (e.g., data records), merging two or more matching data records, and/or the like. For example, the dynamic entity resolution engine 712 can merge a first data record with a second data record and maintain the second data record and disregard (e.g., delete, ignore) the first data record in any subsequent operations. In another example, the merging engine 1996 may create a new data record from the first and second data records and disregard the first and second data records in any subsequent operations.

In some embodiments, dynamic masking can maintain data usability for internal processing and algorithms. In particular, dynamic entity resolution engine 712 can perform entity resolution (e.g., matching and merging) utilizing the actual PII values even if they are masked to most users. For example, master data management systems can rely on matching records (e.g., finding duplicate customer records using Social Security Number or phone number). With data masking, the dynamic entity resolution engine 712 can access the true values of masked attributes “behind the scenes,” so that match rules (which can often involve PII) still function accurately. This can be done without exposing the sensitive data to human users who lack permission. In other words, masking does not break or degrade the quality of data unification, the dynamic entity resolution engine 712 can “see” the real values for computational purposes, but end-users cannot, unless permitted. This capability can enable organizations to enhance matching and merging accuracy with masked data still available for entity resolution. This addresses a common challenge, namely, how to comply with privacy regulations by hiding PII from most users, yet still use that PII internally to link records and avoid duplicates. The dynamic entity resolution engine 712 and/or the other engines and systems described herein ensure that data privacy and integrity are both preserved.

In some embodiments, the dynamic entity resolution engine 712 can function to identify candidate data records for potential match identification. More specifically, the dynamic entity resolution engine 712 may identify various data records (e.g., data records of a live multi-tenant enterprise environment). Each data record may be associated with an entity (e.g., person, organization, enterprise, product), and each data record may include various record fields (e.g., first name, last name, social security number, email address, phone number, city, state, county, zip code, area code, country, organization, and the like) and corresponding record field values (e.g., John, Doe, 555-55-5555, john.doe@domain.com, 555-555-5555, Boston, MA, Suffolk, 02109, 617, USA, Acme, and the like). The dynamic entity resolution engine 712 may identify candidate records that have the same corresponding field values, as well as records that have different values, format, structure, and the like. The candidate records may be used by dynamic entity resolution engine 712 to determine matches between data records (e.g., executing rules-based matching operations and/or machine learning-based matching operations on the candidate records to determine matches).

The management engine 714 may is intended to represent an engine that can manage (e.g., create, read, update, delete, or otherwise access). The management engine 714 can perform any of these operations manually (e.g., by a user interacting with a GUI) and/or automatically (e.g., triggered by one or more of the engines 702-714). Like the other engines described herein, some or all the functionality of the management engine 202 can be included in and/or cooperate with one or more other engines (e.g., engines 702-714) and datastores (e.g., API-centric dynamic masking system datastore 720). In some embodiments, the management engine 714 manage data stored by remote systems (e.g., back-end provider systems 602) and/or datastores of the API-centric dynamic masking system 606 (e.g., API-centric dynamic masking system 720).

In some embodiments, the management engine 714 can access a plurality of datasets. The plurality of datasets can include personally identifiable information (PII). For example, the management engine 714 can access datasets stored on back-end-provider systems (e.g., back-end provider systems 602) and/or datasets stored on/by the multi-tenant platform 102 (e.g., MDM datastores 720).

The interface engine 716 is intended to represent an engine that presents visual, audio, and/or haptic information. In some implementations, the interface engine 716 generates graphical user interface components (e.g., server-side graphical user interface components) that can be rendered as complete graphical user interfaces on various systems (e.g., client systems). The interface engine 716 can function to present an interactive graphical user interface for display and receiving information.

In some embodiments, the interface engine 716 may function to send requests, transmit and receive communications, and/or otherwise provide communication with one or more of the systems, engines, devices and/or datastores described herein. In a specific implementation, the interface engine 716 may function to encrypt and decrypt communications. The interface engine 716 may function to send requests to and receive data from one or more systems through a network or a portion of a network. In a specific implementation, the interface engine 716 may send requests and receive data through a connection, all or a portion of which can be a wireless connection. The interface engine 716 may request and receive messages, and/or other communications from associated systems and/or engines. Communications may be stored in the API-centric dynamic masking system datastore 720.

In some embodiments, the interface engine 716 can function to present graphical user interface elements of graphical user interfaces. More specifically, the interface engine 1918 may generate graphical user interface elements indicating a type of process used to determine a match. For example, one graphical user interface element may indicate that a match was determined using match rules, while another graphical user interface element may indicate that a match was determined using machine learning. This can allow a user to have more confidence when determining whether to merge records. For example, having both indications may increase the likelihood that the data records match.

In some embodiments, the interface engine 716 provides a mask preview so that administrators and/or other users can test how a masked value would look given their chosen pattern before applying it. This can help avoid misconfiguration.

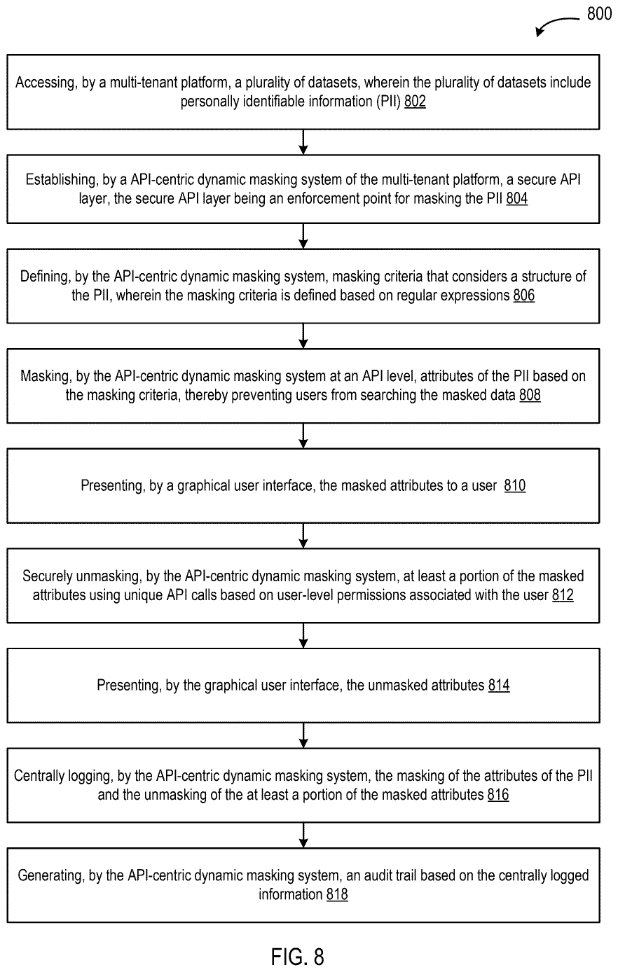

FIG. 8 depicts a flowchart 800 of an example method of API-centric masking with dynamic user-level control. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 802, a multi-tenant platform (e.g., multi-tenant platform 102) accesses a plurality of datasets. The plurality of datasets can include personally identifiable information (PII). For example, the multi-tenant platform 102 may access datasets stored on back-end-provider systems (e.g., back-end provider systems 602) and/or datasets stored on/by the multi-tenant platform 102 (e.g., MDM datastores 720). In some embodiments, a management engine (e.g., management engine 714) access the plurality of datasets.

In module 804, an API-centric dynamic masking system (e.g., API-centric dynamic masking system 606) establishes a secure API layer (e.g., secure API layer 606). The secure API layer can be an enforcement point for masking the PII and/or other data. In some embodiments, secure API layer generation engine (e.g., secure API layer generation engine 702) establishes the secure API layer.

In module, 806, the API-centric dynamic masking system defines masking criteria that considers a structure of the PII. The masking criteria can be defined based on regular expressions and/or contextual information (e.g., user-roles, user permissions, audit histories, etc.). In some embodiments, a dynamic masking engine (e.g., dynamic masking engine 704) defines the masking criteria.

In module, 808, the API-centric dynamic masking system masks attributes of the PII based on the masking criteria, thereby preventing users from searching the masked data. In some embodiments, the dynamic masking engine masks the attributes.

In module, 810, the API-centric dynamic masking system presents, by a graphical user interface, the masked attributes to a user. For example, the secure API layer may enforce the masking and cause an interface engine (e.g., interface engine 716) to cooperate with a client system (e.g., client system 604) to display the masked attributes on the client system.

In module, 812, the API-centric dynamic masking system securely unmasks at least a portion of the masked attributes using unique API calls based on user-level permissions associated with the user. In some embodiments, a secure unmasking engine (e.g., secure unmasking engine 706) securely unmasks the masked attributes.

In module, 814, the API-centric dynamic masking system presents, by the graphical user interface, the unmasked attributes. For example, the secure API layer may enforce and/or check (e.g., real-time user-role permission checks) the unmasking (e.g., to ensure unmasked attributes can be transmitted outside the platform 102) and cause the interface engine to cooperate with the client system to display the unmasked attributes on the client system.

In module, 816, the API-centric dynamic masking system centrally logs the masking of the attributes of the PII and the unmasking of the at least a portion of the masked attributes. In some embodiments, a central logging engine (e.g., central logging engine 708) logs the masking and unmasking.

In module, 818, the API-centric dynamic masking system generates an audit trail based on the centrally logged information. In some embodiments, a secure audit engine (e.g., secure audit engine 710) generates the audit trail.

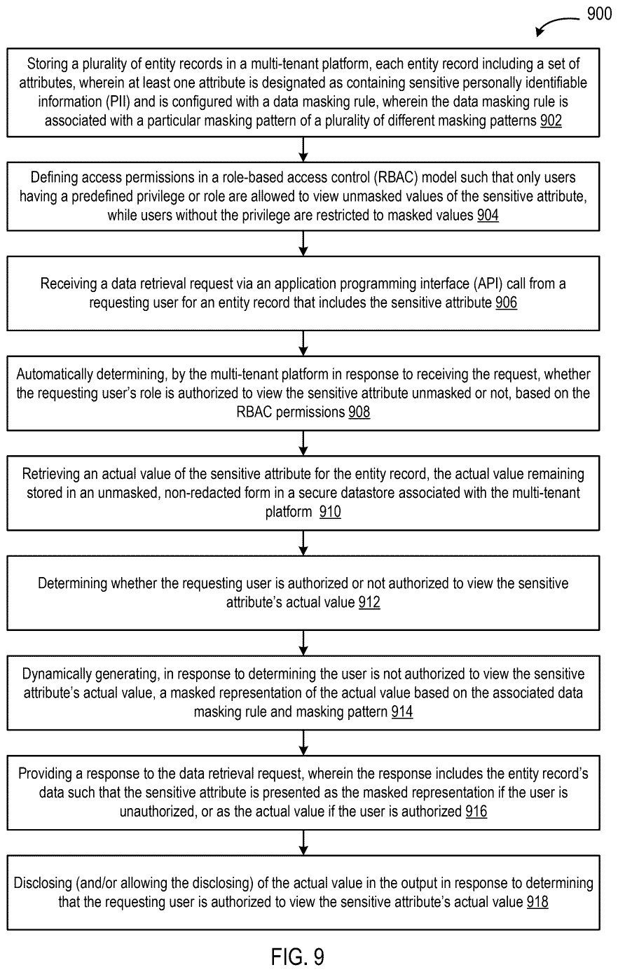

FIG. 9 depicts a flowchart of an example method of API-centric masking with dynamic user-level control. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 902, a multi-tenant platform (e.g., multi-tenant platform 102) stores a plurality of entity records. Each entity record can include a set of attributes, wherein at least one attribute is designated as containing sensitive personally identifiable information (PII) and is configured with a data masking rule. The data masking rule can be associated with a particular masking pattern of a plurality of different masking patterns. In some embodiments, the data masking rules and/or masking patterns can be defined, maintained, stored, and/or otherwise managed by an API-centric dynamic masking system (e.g., API-centric dynamic masking system 606). For example, a dynamic masking engine (e.g., dynamic masking engine 704) can perform such functionality.

In some embodiments, the plurality of different masking patterns includes full masking of the attribute's value, partial masking that hides a specified subset of characters of the value, and a custom masking pattern defined by one or more regular expressions (e.g., an administrator-provided regular expression. For example, an administrator can supply a regular expression pattern that matches a portion of the attribute value, and the configuration can include a Boolean value that controls whether the matched portion is masked or the unmatched portion is masked:

In some embodiments, the data masking rule for the sensitive attribute is configurable through a graphical user interface of the multi-tenant platform, thereby allowing a user to select the masking pattern or define the custom masking expression, and to specify which user roles have unmasking privileges for that attribute in order for different attributes to have different masking patterns and permission settings within the multi-tenant platform.

In some embodiments, the multi-tenant platform is configured to access and utilize the actual values of masked sensitive attributes during automated duplicate detection or merge operations, and retrieval of those attributes complies with the masking rules, thereby maintaining data privacy without hindering the accuracy of entity resolution within the multi-tenant platform.

In module 904, the API-centric dynamic masking system defines access permissions in a role-based access control (RBAC) model such that only users having a predefined privilege or role are allowed to view unmasked values of the sensitive attribute, while users without the privilege are restricted to masked values. In some embodiments, the dynamic masking engine defines the access permissions.

In module 906, the API-centric dynamic masking system receives a data retrieval request via an application programming interface (API) call from a requesting user for an entity record that includes the sensitive attribute. In some embodiments, the interface engine receives the request (e.g., via a secure API layer generated by the secure API layer generation engine 702) and provides the request the dynamic masking engine.

In module 908, the API-centric dynamic masking system automatically determines in response to receiving the request, whether the requesting user's role is authorized to view the sensitive attribute unmasked or not, based on the RBAC permissions. In some embodiments, the dynamic masking engine automatically determines whether the requesting user's role is authorized to view the sensitive attribute unmasked or not, based on the RBAC permissions.

In module 910, the API-centric dynamic masking system retrieves an actual value of the sensitive attribute for the entity record, the actual value remaining stored in an unmasked, non-redacted form in a secure datastore associated with the multi-tenant platform (e.g., API-centric dynamic masking system datastore 720). In some embodiments, the dynamic masking engine retrieves (e.g., in cooperation with the management engine 702) retrieves the actual value.

In module 912, the API-centric dynamic masking system determines whether the requesting user is authorized or not authorized to view the sensitive attribute's actual value. In some embodiments, the dynamic masking engine determines whether the requesting user is authorized or not authorized to view the sensitive attribute's actual value.

In step 914, the API-centric dynamic masking system dynamically generates, in response to determining the user is not authorized to view the sensitive attribute's actual value, a masked representation of the actual value based on the associated data masking rule and masking pattern. In some embodiments, the dynamic masking engine generates the masked representation (e.g., obfuscated values of the actual value).

In some embodiments, dynamically generating the masked representation comprises substituting a portion or entirety of the actual value with masked characters as specified by the masking pattern (e.g., including applying any administrator-defined custom mask expression).

In step 916, the API-centric dynamic masking system provides a response to the data retrieval request, wherein the response includes the entity record's data such that the sensitive attribute is presented as the masked representation if the user is unauthorized, or as the actual value if the user is authorized. In some embodiments, the dynamic masking engine generates the response and the interface engine provides the response (e.g., via the secure API layer).

In step 918, the API-centric dynamic masking system discloses (and/or allows the disclosure) of the actual value in the output in response to determining that the requesting user is authorized to view the sensitive attribute's actual value. In some embodiments, a secure unmasking engine (e.g., secure unmasking engine) discloses the actual value, which can be provided to other entities by the interface engine.

In some embodiments, responses delivered via different access channels all consistently apply the masking rules, including displaying masked values in the platform's graphical user interface for users lacking unmask permissions, returning masked values in API responses and data export files for unauthorized consumers, and logging or auditing any events of actual values being revealed to authorized users for compliance monitoring. Access channels can include, for example, a UI channel (e.g., users viewing data in applications), an API channel (e.g., external systems, and the UI itself, reading data through APIs with masking enforced at the API level (e.g., by the secure API layer 608), and a data export channel (e.g., exported datasets/files).

This can, for example, help ensure that sensitive data is protected by default in all user-interface and API outputs while still enabling internal data processing functions to utilize the true sensitive values, and internal matching or merging algorithms operating within the master data management system can continue to access the actual values of masked attributes to identify duplicate records or link records representing the same real-world entity, without exposing the actual sensitive data to users lacking the requisite privilege.

In some embodiments, the multi-tenant platform simultaneously enforces the masking rule on an external output path associated with the requesting user for at least one externally observable channel including any of a user-interface response, an API response, and a data-export output, and (ii) uses the actual value of the sensitive attribute to perform match-and-merge processing operations using the actual value, without including the actual value in the external output path when the requesting user lacks the predefined privilege. The output path, more specifically, can refer to a computing system-side (e.g., server-side) software pipeline that prepares data to leave the platform 102 and become externally observable. For example, output paths can include API response generation (e.g., build a response object, then apply masking rules, then serialize to JSON, and then send over HTTP), API-driven UI rendering (e.g., same underlying response generation pipeline, but consumed by the UI), and export generation (e.g., assemble records, then apply masking rules, then serialize to CSV/JSON/parquet/etc., and then write to an export file or location.

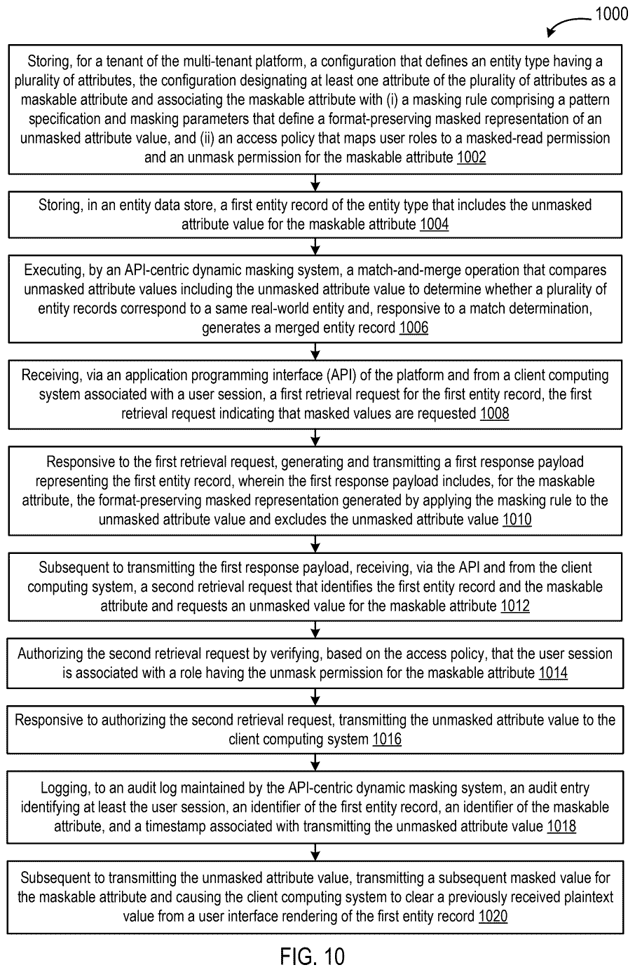

FIG. 10 depicts a flowchart of an example method of API-centric masking with dynamic user-level control. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1002, a multi-tenant platform (e.g., multi-tenant platform 102) stores, for a tenant of the multi-tenant platform, a configuration that defines an entity type having a plurality of attributes. The configuration can designate at least one attribute of the plurality of attributes as a maskable attribute and associate the maskable attribute with (i) a masking rule comprising a pattern specification and masking parameters that define a format-preserving masked representation of an unmasked attribute value, and (ii) an access policy that maps user roles to a masked-read permission and an unmask permission for the maskable attribute. In some embodiments, an API-centric dynamic masking system (e.g., API-centric dynamic masking system 606) of the multi-tenant platform 102 stores the configuration (e.g., in datastore 720). In some embodiments, a dynamic masking engine (e.g., dynamic masking engine 704) defines the configuration.

In some embodiments, the pattern specification comprises a regular expression, and applying the masking rule comprises identifying, using the regular expression, a matching substring of the unmasked attribute value and selectively masking either (i) the matching substring or (ii) a non-matching substring based on a configuration flag. In some embodiments, the regular expression corresponds to a suffix-length expression that preserves a trailing portion of the unmasked attribute value.

In some embodiments, the masking rule specifies a full masking mode that replaces each character of the unmasked attribute value with a masking character to render the value unrecognizable. In some embodiments, the masking rule specifies an email masking mode that masks a user-name portion of an email address while preserving a domain portion. In some embodiments, the masking rule specifies a first-N or last-N masking mode that preserves a first N characters or a last N characters of the unmasked attribute value and masks remaining characters.

In module 1004, the multi-tenant platform stores, in an entity data store (e.g., datastore 720), a first entity record of the entity type that includes the unmasked attribute value for the maskable attribute. In some embodiments, a management engine (e.g., management engine 702) stores the first entity record.

In module 1006, the API-centric dynamic masking system executes, by an API-centric dynamic masking system, a match-and-merge operation that compares unmasked attribute values including the unmasked attribute value to determine whether a plurality of entity records correspond to a same real-world entity and, responsive to a match determination, generates a merged entity record. In some embodiments, a dynamic entity resolution engine (e.g., dynamic entity resolution engine 712) executes the operation.

In some embodiments, the match-and-merge operation uses the unmasked attribute value as an input to matching while the first response payload includes only the masked representation for the maskable attribute.

In module 1008, the API-centric dynamic masking system receives, via an application programming interface (API) (e.g., secure API layer 608 generated by secure API layer generation engine 702) of the multi-tenant platform and from a client computing system (e.g., client system 604) associated with a user session, a first retrieval request for the first entity record, the first retrieval request indicating that masked values are requested. In some embodiments, an interface engine (e.g., interface engine 716) receives the request by the secure API layer.

In some embodiments, the first retrieval request includes a sendMasked parameter set to request masked values. In some embodiments, a default value of the sendMasked parameter is configured to preserve backward compatibility with a client component that does not request masked values.

In module 1010, the API-centric dynamic masking system, responsive to the first retrieval request, generates and transmits a first response payload representing the first entity record. The first response payload can include, for the maskable attribute, the format-preserving masked representation generated by applying the masking rule to the unmasked attribute value and excludes the unmasked attribute value. In some embodiments, the dynamic entity resolution engine generates and transmits the first response payload.

In module 1012, the API-centric dynamic masking system, subsequent to transmitting the first response payload, receives, via the API and from the client computing system, a second retrieval request that identifies the first entity record and the maskable attribute and requests an unmasked value for the maskable attribute. In some embodiments, these operations are performed by the dynamic entity resolution engine 712.

In module 1014, the API-centric dynamic masking system authorizes the second retrieval request by verifying, based on the access policy, that the user session is associated with a role having the unmask permission for the maskable attribute. In some embodiments, the dynamic entity resolution engine 712 authorizes the second retrieval request.

In module 1016, the API-centric dynamic masking system, responsive to authorizing the second retrieval request, transmits the unmasked attribute value to the client computing system. In some embodiments, the dynamic entity resolution engine and/or interface engine transmits the second retrieval request.

In module 1018, the API-centric dynamic masking system logs, to an audit log maintained by the API-centric dynamic masking system, an audit entry identifying at least the user session, an identifier of the first entity record, an identifier of the maskable attribute, and a timestamp associated with transmitting the unmasked attribute value. In some embodiments, the central logging engine (e.g., central logging engine 708) logs the audit entry.

In some embodiments, the audit entry further identifies at least one of a client application identifier, a network address associated with the client computing system, or a user identifier.

In module 1020, the API-centric dynamic masking system, after transmitting the unmasked attribute value, transmits a subsequent masked value for the maskable attribute and causes the client API-centric dynamic masking system to clear a previously received plaintext value from a user interface rendering of the first entity record.

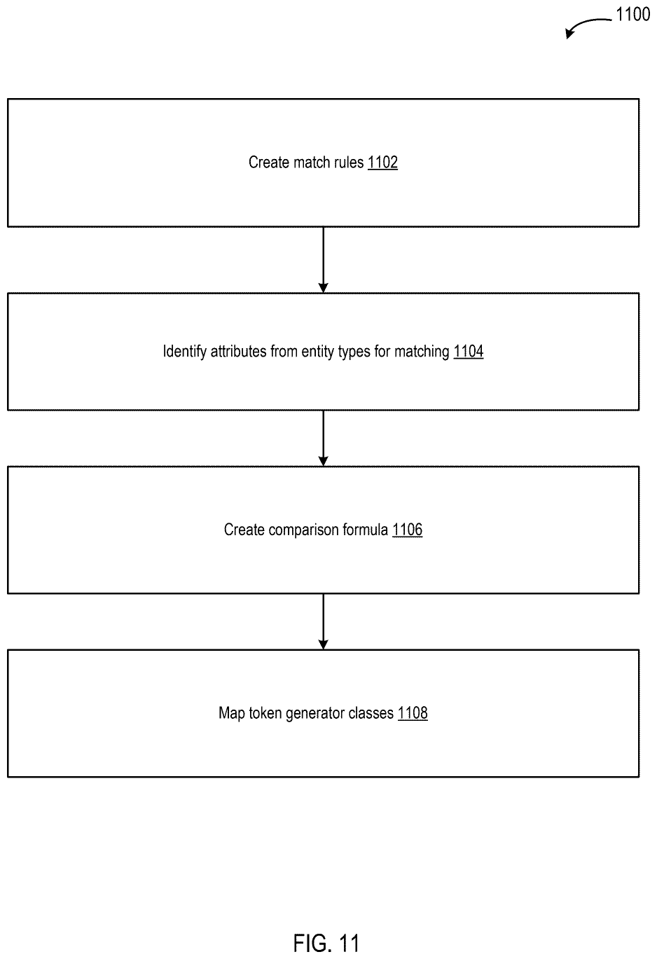

FIG. 11 depicts a dynamic matching facilitation flowchart. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The match architecture is responsible for identifying profiles within the tenant that are considered to be semantically the same or similar. A user may establish a match scheme using the match configuration framework. In some embodiments, the user may utilize machine learning techniques to match profiles. In step 1102, the user may create match rules. In step 1104, the user may identify the attributes from entity types they wish to use for matching. In step 1106, the user may write a comparison formula within each match rule which is responsible for doing the actual work of comparing one profile to another. In step 1108, the user may map token generator classes that will be responsible for creating match candidates.

Unlike other systems, in various embodiments, the architecture is designed to operate in real time. Prior to the match process and merge processes occurring, every profile created or updated may be cleansed on the fly by the profile-level cleansers. Thus, the 3-step sequence of cleanse, match, and merge may be designed to all occur in real time anytime a profile is created or updated. This behavior makes the platform 102 ideal for real-time operational use within a customer's ecosystem.

Lastly, the survivorship architecture is responsible for creating the classic “golden record,” but in a specific implementation, it is a view materialized on the fly. It is returned to any API call fetching the profile and contains a set of “Operational Values” from the profile, which are selected in real time based on survivorship rules defined for the entity type.

In various embodiments, matching may operate continuously and in real time. For example, when a user creates or updates a record in the tenant, the platform cleanses and processes the record to find matches within the existing set of records.

Each entity type (e.g., contact, organization, product) may have its own set of match groups. In some embodiments, each match group holds a single rule along with other properties that dictate the behavior of the rule within that group. Comparison Operators (e.g., Exact, ExactOrNull, and Fuzzy) and attributes may comprise a single rule.

Match tokens may be utilized to help the match engine quickly find candidate match values. A comparison formula within a match rule may be used to adjudicate a candidate match pair and will evaluate to true or false (or a score if matching is based on relevance).

In some embodiments, the matching function may do one of three things with a pair of records: Nothing (if the comparison formula determines that there is no match); Issue a directive to merge the pair; Issue a directive to queue the pair for review by a data steward. In some embodiments, the architecture may include the following:
1) Entities and relationships each have configurable attribution capability.
2) Values found in an attribute are associated with a crosswalk held within an entity or relationship object. Each profile can have multiple crosswalks, each contributing one or more values. Data may come from multiple sources. Each source may be registered, and all data loaded into a tenant will be associated with a data source. Each supplied attribute may be associated with data provider crosswalks. Crosswalks are analogous to the Primary Key or Unique Identifier in a relational database management system (RDBMS). A crosswalk can represent a data provider or a non-data provider.
3) Data providers supply attribute values for an object and the attributes are associated with the crosswalk.
4) Non-data providers are associated with an overall entity (or relationship). In this case it is simply used to link a Reltio object with an object in another system. Supplied attributes may NOT be associated with this crosswalk.
5) Profiles can be matched and merged, but relationships are also matched and merged. While the user may develop match rules to govern the matching and merging of profiles, the merging of relationships is automatic and intrinsic to the platform. Any two relationships of the same type, that each have entity A at one endpoint and entity B at their other endpoint, will merge automatically.
6) An attribute is intrinsically multi-valued, meaning it can hold multiple values. This means any attribute can collect and store multiple values from contributing sources or through the merging of additional crosswalks. Thus, if a match rule utilizes the first name attribute, then the match engine will by default, compare all values held within the first name attribute of record A to all values held within the first name attribute of record B, looking for matches among the values. The user may elect to only match on operational values if desired.
7) When two profiles merge, the resulting profile contains the aggregate of all the crosswalks of the two contributing profiles and, thus, the associated attributes and values from those crosswalks. The arrays behind the attributes naturally merge as well, producing for each attribute an array that holds the aggregation of all the values from the contributing attributes. Relationships benefit from the same architecture and behave in the same manner as described for merged entities. The surviving entity ID (or relationship ID) for the merged profile (or relationship) is that of the oldest of the two contributors. Other than that, there really isn't a concept of a winner object and a loser object.
8) When two profiles merge the resulting profile contains references to all the interactions that were previously associated with the contributing profiles. (Note that Interactions do not reference relationships.)
9) If profile B is unmerged from the previous merge of A and B, then B will be reinstated with its original entity ID. All of the attributes (and associated values), relationships, and interactions profile B brought into the merged profile will be removed from the merged profile and returned to profile B.

The matchGroups construct is a collection of match groups with rules and operators that are needed for proper matching. If the user needs to enable matching for a specific entity type in a tenant, then the user may include the matchGroups section within the definition of the entity type in the metadata configuration of the tenant. The matchGroups section will contain one or more match groups, each containing a single rule and other elements that support the rule.

Looking at a match group in a JSON editor, the user can easily see the high-level, classic elements within it. The rule may define a Boolean formula (see the AND operator that anchors the Boolean formula in this example) for evaluating the similarity of a pair of profiles given to the match group for evaluation. It is also within the rule element that four other very common elements may be held: ignoreInToken (optional), Cleanse (optional), matchTokenClasses (required), and comparatorClasses (required). The remaining elements that are visible (URI, label, and so on), and some not shown in the snapshot, surround the rule and provide additional declarations that affect the behavior of the group and in essence, the rule.

Each match group may be designated to be one of four types: automatic, suspect, <custom>, and relevance_based described below. The type the user selects may govern whether the user develops a Boolean expression for the comparison rule or an arithmetic expression. The types are described below.

Behavior of the automatic type: With this setting for type, the comparison formula is purely Boolean and if it evaluates to TRUE, the match group will issue a directive of merge which, unless overridden through precedence, will cause the candidate pair to merge.

Behavior of the suspect type: With this setting for type, the comparison formula is purely Boolean and if it evaluates to TRUE, the match group will issue a directive of queue for review which, unless overridden through precedence, will cause the candidate pair to appear in the “Potential Matches View” of the MDM UI.

Behavior of the relevance_based type: Unlike the preceding rules, all of which are based on a Boolean construction of the rule formula, the relevance-based type expects the user to define an arithmetic scoring algorithm. The range of the match score determines whether to merge records automatically or create potential matches.

If a negativeRule exists in the matchGroups and it evaluates to true, any merge directives from the other rules are demoted to queue for review. Thus, in that circumstance, no automatic merges will occur. The Scope parameter of a match group defines whether the rule should be used for Internal Matching or External Matching or both. External matching occurs in a non-invasive manner and the results of the match job are written to an output file for the user to review. Values for Scope are: ALL—Match group is enabled for internal and external matching (Default setting). NONE—Matching is disabled for the match group. INTERNAL—Match group is enabled for matching records within the tenant only. EXTERNAL—Match group is enabled only for matching of records from an external file to records within the tenant; in a specific implementation, external matching is supported programmatically via an External Match API and available through an External Match Application found within a console, such as a RELTIO™ Console.

If set to true, then only the OV of each attribute will be used for tokenization and for comparisons. For example, if the First Name attribute contains “Bill”, “William”, “Billy”, but “William” is the OV, then only “William” will be considered by the cleanse, token, and comparator classes.

The rule is the primary component within the match group. It contains the following key elements each described in detail: IgnoreInToken, Cleanse, matchTokenClasses, comparatorClasses, Comparison formula.

A negative rule allows a user to prevent any other rule from merging records. A match group can have a rule or a negative rule. The negative rule has the same architecture as a rule but has the special behavior that if it evaluates to true, it will demote any directive of merge coming from another match group to queue for review. To be sure, most match groups across most customers' configurations use a rule for most matching goals. But in some situations, it can be advantageous to additionally dedicate one or more match groups to supporting a negative rule for the purpose of stopping a merge based on usually a single condition. And when the condition is met, the negative rule prevents any other rule from merging the records. So in practice, the user might have seven match groups each of which use a rule, while the eighth group uses a negative rule.

The platform 102 may include a mechanism to proactively monitor match rules in tenants across all environments. In some embodiments, after data is loaded into the tenant, the proactive monitoring system inspects every rule in the tenant over a period of time and the findings are recorded. Based on the percentage of entities failing the inspections, the proactive monitoring system detects and bypasses match rules that might cause performance issues and the client may be will be notified. The bypassed match rules will not participate in the matching process.

In various embodiments, the user receives a notification when the proactive monitoring system detects a match rule that needs review. ScoreStandalone and scoreIncremental elements may be used to calculate a Match Score for a profile that is designated as a potential match and can assist a data steward when reviewing potential matches.

Relevance-based matching is designed primarily as a replacement of the strategy that uses automatic and suspect rule types. With Relevance-based matching, the client may create a scoring algorithm of the user's own design. The advantage is that in most cases, a strategy based on Relevance-based matching can reduce the complexity and overall number of rules. The reason for this is that the two directives of merge and queue for review which normally require separate rules (automatic and suspect respectively) can often be represented by a single Relevance-Based rule.

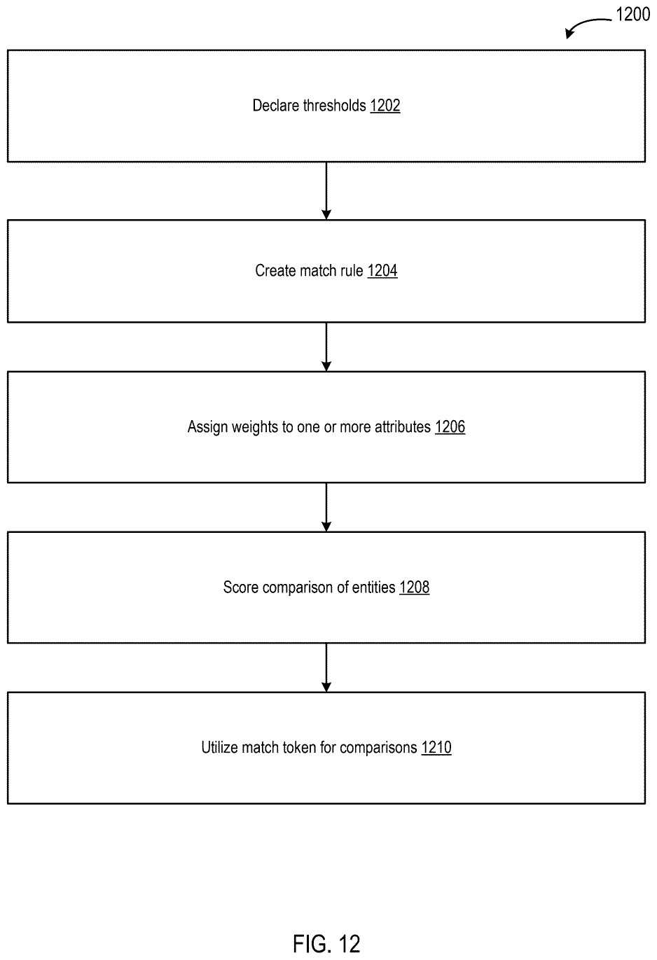

FIG. 12 depicts a dynamic matching flowchart. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1202, thresholds may be defined. For example, when declaring the ranges for queue_for_review and auto_merge, the combination should span the entire available range of 0.0 to 1.0 with no gap and no overlap except that the upper endpoint for queue_for_review should equal the lower endpoint for auto_merge thus have a common touchpoint between them (for example, 0.0 to 0.6 for queue_for_review, and 0.6 to 1.0 for auto_merge). If the actionThresholds leave a gap, then any score falling within the gap will produce no action. Conversely, if the actionThresholds overlap (for example, 0.4 to 0.6 for queue_for_review, and 0.5 to 0.7 for auto_merge) and a score lands within the intersection (0.55 in our example) or on the touchpoint, the directive of queue_for_review takes precedence.

In step 1204, match rules are created. Using Relevance-based matching, the client could create a match rule that contains a collection of attributes to test as a group.

In step 1206, weights may be assigned to attributes to govern their relative importance in the rule. Weights can be set from 0.0 to 1.0. If the client does not explicitly set a weight for an attribute, it may receive a default weight of 1.0 during execution of the rule. For example, starting with all weights equal to 1.0 and perhaps start with actionThresholds of 0.0-0.5 for queue_for_review and 0.5-1.0 for auto_merge. Do some trial runs and examine the results. If too many obvious matches are being set to queue_for_review, then weights may be adjusted and the actionThresholds modified (e.g., to perhaps 0.0-0.7, and 0.7-1.0). The user may iterate and experiment until able to get optimized results with the data set.

In step 1208, score comparison of entities is performed. In step 1210, the relevance_based match rules use the match token classes in the same way as they are used in suspect and automatic match rules. However, the comparison of the two entities works differently. Every comparator class provides relevance value while comparing values. The relevance is in the range of 0 to 1. For example, BasicStringComparator returns 0 if two values are different. It returns 1 if two values are the identical. Fractional values can be a result of DistinctWordsComparator or other comparators. Every attribute has assigned weights according to the importance of the attribute. If the weight is not assigned explicitly then it is equal to 1 for the simple attributes or Maximum of the weights of sub-nested attributes for nested or reference attributes. If an attribute has multiple values, then the maximum value of relevance is selected.

In various embodiments, the following information describes participants of the formulae: RelevanceScoreAND—the relevance score of AND operand, the relevance score of the match rule; Nsimple—number of simple attributes (e.g., FirstName, LastName) participating in the AND operator directly; weighti—configured weight of i-th simple attribute; relevancei—calculated relevance of i-th simple attribute; Nnest—number of nested and reference attributes (e.g., Phone-no, Email-ID, Address) participating in the AND operator directly; weightj—configured weight of j-th nested or reference attribute; relevancej—calculated relevance of j-th nested/reference attribute; Nlogical—number of logical operands (For example, AND or OR) participating in the AND operator directly; relevancek—calculated relevance of k-th logical operand (the weight of a logical operand is fixed to 1; RelevanceScoreOR=max(relevance1, . . . , relevancei, . . . , relevanceN) relevancei-relevance of simple attribute, nested attribute, logical operand participating in the OR operand directly; RelevanceScoreNOT=1−RelevanceScoreAND,OR,exact, . . . (The relevance score of the NOT operand is equal to 1 minus the relevance score of the operand having this negation.)

In various embodiments, the following information describes participants of the formulae:

$${RelevanceScore}_{AND} = \frac{{\sum }_{i = 1}^{{N}_{simple}} {weight}_{i} \cdot {relevance}_{i} + {\sum }_{j = 1}^{N \text{?}} {weight}_{j} \cdot {relevance}_{j} + {\sum }_{k = 1}^{{N}_{logical}} {relevance}_{k}}{{\sum }_{i = 1}^{{N}_{simple}} {weight}_{i} + {\sum }_{j = 1}^{N \text{?}} {weight}_{j} + {N}_{logical}}$$

$$\text{?} \text{indicates text missing or illegible when filed}$$

BasicStringComparator provides the relevance values and the score is calculated as follows: true for First Name; true for LastName; false for Suffix. The score is calculated as (1*1+1*1+0*1)/(1+1+1)=?=0.66. With a score of 0.66 the directive for this pair will be set to queue_for_review.

The example below shows the use of the verifyMatches API when using Relevance-based matching. Noteworthy items are relevance values appear for every attribute comparison and relevance for the entire rule; Match action name is shown if the relevance is within the corresponding threshold range, and null if it is not within any actionThreshold range; Matched field will be true if the relevance is within any actionThreshold range.

In the match group configuration, the user may define Weights and actionThresholds. The weight property allows the client to assign a relative weight (strength) for each attribute. For example, the user may decide that Middle Name is less reliable and thus less important than First Name.

The actionThreshold allows the client to define a range of scores to drive a directive. For example, the user might decide that the match group should merge the profile pair if the score is between 0.9 to 1.0, but should queue the pair for review if the score falls into a lower range of 0.6 to 0.9.

The user can configure a relevance-based match rule with multiple action thresholds having the same action type but with a different relevance score range.

In the above example, the type is potential_match for two different action thresholds. The user can differentiate such thresholds by assigning appropriate labels. The user can generate potential matches with different labels based on the range of the relevance score that allows the user to differentiate between higher and lower relevance score matches. The user can resolve matches quickly based on the label. In the example above, based on the relevance score, some potential matches can be considered for merging directly while others must be reviewed before any action is taken. The results of the API to get potential matches and the external match API will contain a relevance value and a matchActionLabel corresponding to each of the action type configured under the actionThreshold parameter. For more information, see Potential Matches API and External Match API.

Using operators like equals and notEquals prevents tokenization from generating tokens. These operators should not have an impact on tokenization, if we want to compare and conclude that even though address and/or email and/or phone are different, the remaining attributes match enough to take the score above the threshold.

In some embodiments, the following options equal, notEquals and in constraints: 1) strict (Boolean value with default=true): Allows the constraint to be skipped before the match tokens and relevance score are computed; 2) weight (decimal with default=0.0): Allows the constraint to participate in the relevance score calculation. (The two options and their default values ensure backward compatibility.)

An example of a formula to calculate relevance score is:

$$R = \frac{{\sum }_{i}^{N} {{R}^{operand}}_{i} \cdot {{w}^{operand}}_{i} + {\sum }_{i}^{N} {{R}^{constraint}}_{i} \cdot {{w}^{constraint}}_{i}}{{\sum }_{i}^{N} {{w}^{operand}}_{i} + {\sum }_{i}^{N} {{w}^{constraint}}_{i}}$$

The formulae have the following variables: Roperand—the relevance score of an operand (for example: exact, exactOrNull, exactOrAllNull, fuzzy, etc.); Rconstraint—the relevance score calculated for a constraint (for example: equals, notEquals, in); Woperand—configured weight for an operand; Wconstraint—configured weight for a constraint.

In at least some organizations, profiles are maintained across systems and there are instances where multiple records of the same profile exist. There may be inconsistencies in each record. In such cases, it would be beneficial to merge these records and maintain one record with the complete information. There are also instances where two profiles are related to each other.

There are certain match pairs that the user can configure such that the system can automatically take action on those. Other match pairs that require manual review are resolved using the Potential Match screen. Match rules and Match IQ (discussed herein) may be utilized to determine if two records are a match, not a match, or a potential match.

Match rules and Match IQ may be used to determine if two records are a match, not a match, or a potential match. The user can also use the Match Score to decide if a profile is a potential match. Based on predefined match rules, each potential match is given a Match Score and the higher the score, higher is the probability of it to be a potential match for the profile. In some embodiments, the Match Score of a potential match will have a value of more than 0 only if the standalone and incremental scores are configured for the match rules.

There may be instances when certain profiles, in spite of being a potential match, are excluded from the profile view due to these match rules. In such cases, the user can manually search by entering the search criteria in the “Search” field and include these profiles as potential matches.

The user may have the option of viewing the Potential Matches perspective in the classic mode or the new mode.

In various embodiments, Match IQ uses machine learning (ML) to simplify and accelerate the data matching process. With Match IQ, business users can easily create a model for matching the records, by simply selecting the entity type and related attributes, without or minimum IT help. They can then train the ML model with the active learning process by reviewing pairs of records and indicating which are a match and which are not. As users confirm the matches, machine learning adjusts the matching model and presents additional record pairs to further refine the model.

After a sufficient number of representative record pairs have been matched or not matched, the user can download and review the match results. A downloaded file may show a sample set of match results and a relevance score for each record pair. The higher the relevance score, the more likely the records match. If needed, the user can retrain the model by answering more questions or even creating an alternate model to compare the matching results.

After the results are satisfactory, the data steward or other user with approval authority can review, approve and publish the model to use with internal and/or external data. The user also provides publishing settings based upon the relevance score range—for example, to define that match pairs with a relevance score of 0.8 to 1 should be matched and merged.

The end-to-end process, driven and performed by business users, typically takes only a day or two to complete and produces the quality matches customers require. In some embodiments, Match IQ uses machine learning technology to help ensure unified and reliable data across virtually unlimited data sources. The ML matching model, created with active learning using resolutions of suspected matched pairs, can be effectively applied to future match pairs. This provides a consistent way for business users and data stewards to match and merge data for increased quality, reliability, and business value.

Once a matching model is trained, no user interaction is required but the model can be retrained if needed. Because match and merge operations are performed using these models and calculated relevance scores, the process is rapid, consistent, and reliable. As the business grows or changes, the models can easily be adjusted to accommodate additional data sources. This enables matching and merging at the scale and speed of business.

The streamlined matching process, which does not require IT specialists or coding, enables customers to get up and running faster and with less effort. Typically, they can progress from initial subscription to completing their match-and-merge operations in a matter of days. Compare this to the weeks or months required by more traditional approaches. This same process is used to perform matching for new data sources as they are added, providing additional time savings and increased productivity.

No definition of matching requirements is needed; instead, users select matched pairs and machine learning creates the models. This greatly reduces the possibility of matching requirements not being correctly identified that might generate incorrect matches or miss valid matches. In addition, because machine learning creates and adjusts the matching model without configuration by IT specialists, coding errors are a thing of the past. This not only reduces errors in the match-and-merge process, but it also saves significant time as it creates a repeatable process. Customers have an option to use both Match IQ and traditional rule-based matching together if needed.

With all the time saved by using Match IQ, those involved-data owners, data stewards, IT and other business users-will find they have more time available for work that adds value to the business. They can use their time to focus on creating better user experiences, data improvement initiatives or streamlining other processes.

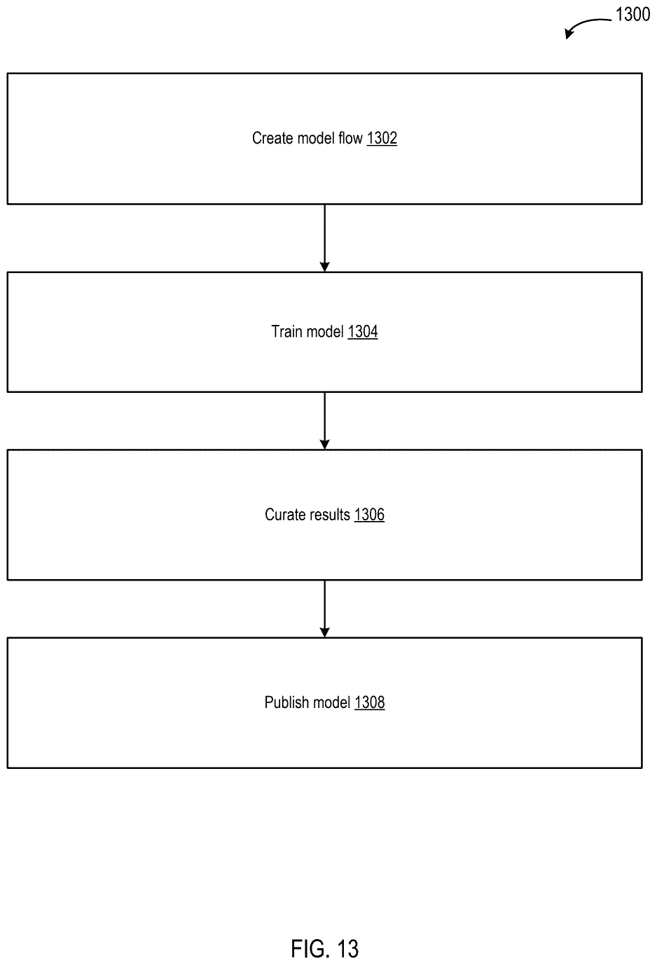

FIG. 13 depicts a high level flowchart for MatchIQ in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1302, the first step is to create a model flow by selecting entity types and attributes. In various embodiments, a graphical user interface may enable a user to select attributes to train the model (e.g., with a check system).

In step 1304, the model is trained. When the user trains a model, the user identifies records as matches or non-matches (e.g., by answering a series of questions). After the completion of the Preparing Data stage, the model moves under the Training lane. At this stage, the model is ready for training. There can be variations where records are neither close to matches nor non-matches. Such records then become the input to the training process where the user may be prompted with questions seeking confirmation on whether a particular pair is a match or not.

A machine learning methodology may be utilized. For example, a neural network may be utilized for training. Alternately, as other examples, gradient boosted decision trees or random forests may be utilized.

In step 1306, results are curated. In various embodiments, the graphical user interface may display details related to the model and results may be displayed (e.g., downloaded). Matches may be run and reviewed by the user to curate the results for further training and model improvement.

In step 1308, the user may publish the model. The user may choose to publish the model for internal and external matching. In some embodiments, the user may select external or internal.

For example, if the user selects external, the model may be used to match data from an external file with the data in the tenant. If the user selects internal, the model may be used to match the data within your tenant along with the match rules configured for the tenant.

In various embodiments, the user may define a custom action and a corresponding relevance score range. This allows the user to execute custom actions for relevance scores that are received for relevance-based rules. If a match pair falls within the defined range, then the custom action is executed. In a specific implementation, the relevance score range the user specifies for one action cannot overlap with the relevance score of another custom action.

In various embodiments, survivorship and merging are separate concepts and processes. Again, think of an entity as a container of crosswalks and their associated attributes and values. A merged entity may be an aggregation of crosswalks from two or more entities. The additional crosswalks continue to bring their own attributes and values with them. If the acquiring (winning) entity already has the same attribute URI that the incoming entity is bringing, then the values from the attributes will accumulate within the attribute, yet the integrity of which crosswalk each value within the attribute came from is maintained for several purposes including the need to return the attribute and its values to the original entity it came from if an unmerge is requested. If the acquiring entity does not already have the same attribute URI that the incoming entity is bringing, then the new attribute URI becomes established within the entity.

In some embodiments, unlike other MDM systems, survivorship is a separate process that doesn't occur during the merge. It is a process that executes in real time when the entity is being retrieved during an API call. Survivorship may not depend on how the crosswalks and attributes came into the consolidated profile nor the order that they arrived. Survivorship processes each attribute according to the attribute's defined survivorship rule, and produces an Operational Value (OV) for the attribute on-the-fly. Depending on the type of survivorship rule selected, there could be one or more OVs for an attribute. For example, the user might choose the aggregation rule for the address attribute for the purpose of returning all addresses a person is related to. Conversely the user might choose the frequency rule for “first name” to return the one name that occurs most frequently in the “first name” attribute. Note also that the role of the username making the API call also factors into the survivorship rule used. This feature allows one survivorship rule for an attribute to be stored with one username role, while another survivorship rule for the same attribute is stored with another username role. A fetch of the entity by each username role might return different OVs.

When configuring the survivorship rules for the attributes of an entity type, the user can do this largely from the UI, but there are some advanced survivorship strategies that may be defined through metadata configuration.

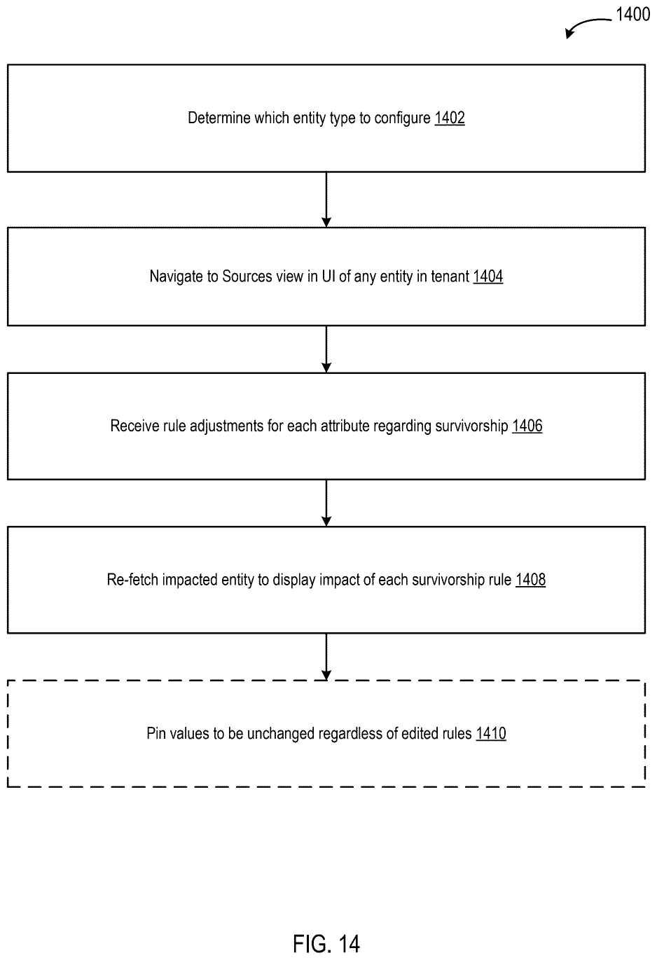

FIG. 14 depicts a flowchart for configuring survivorship within an example UI in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

When configuring survivorship via the UI, the user may not use the UI Modeler or Data Modeler. To configure attribute value survivorship via the UI, in step 1402, the user may determine which entity type to configure, then they may navigate to the Sources view of any actual entity in the tenant in step 1404. It may not matter which entity that is selected but it is recommended that the user pick one that has been sufficiently merged and thus has enough crosswalks (and thus raw values in its attributes) so that the user may witness material effects on-the-fly as they modify the survivorship rules.

In step 1406, in the Sources view while editing the survivorship for each attribute, the user can instantly see the effect on the screen in step 1408, which may guide the user. After you make a rule adjustment, the entity is fetched again using your new version of the rule and so you see the effect instantaneously.

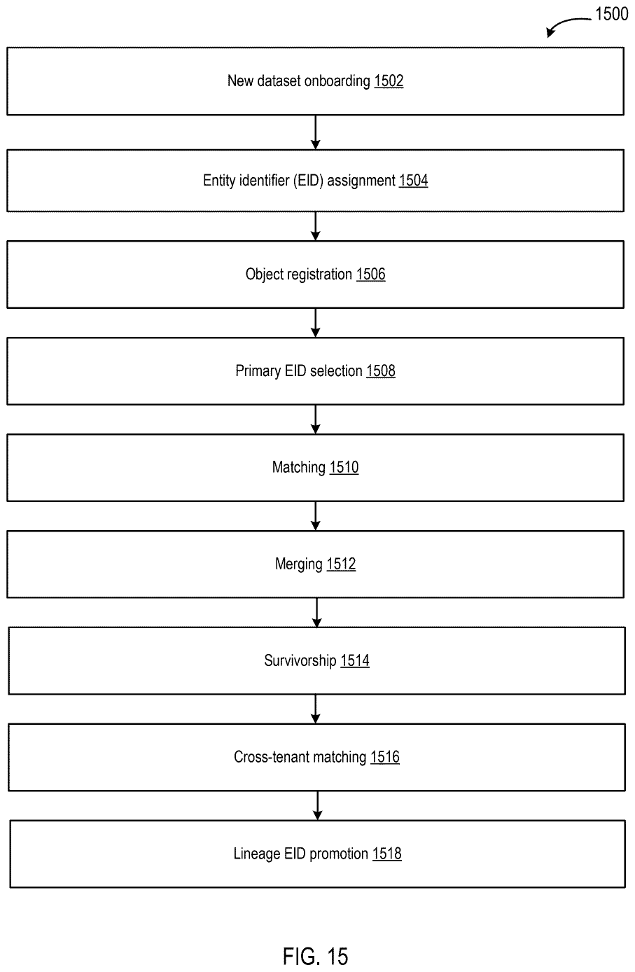

FIG. 15 depicts a flowchart of an example of a method of cross-tenant matching and lineage EID promotion. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The flowchart 1500 starts at module 1502 with new dataset onboarding. New dataset onboarding is described above with reference to a dataset onboarding engine, which can carry out the process. Like the other engines described herein, the dataset onboarding engine may be a component of one or more regional platform instances.

The flowchart 1500 continues to module 1504 with EID assignment. EID assignment can be performed using an EID assignment engine. Like the other engines described herein, the EID assignment engine may be a component of one or more regional platform instances.

The flowchart 1500 continues to module 1506 with object registration. Object registration can be performed by an object registration engine. Like the other engines described herein, the object registration engine may be a component of one or more regional platform instances.

The flowchart 1500 continues to module 1508 with primary EID selection. Primary EID selection would occur naturally for a new object that has only one EID, but for objects that are merged, a primary EID is selected. A primary EID selection engine can carry out the process. Like the other engines described herein, the primary EID selection engine may be a component of one or more regional platform instances.

The flowchart 1500 continues to module 1510 with matching. Matching refers to the matching of objects in a datastore, such tenant datastores and/other datastores or systems. Because of a continuous process of integrating objects into the datastore(s), at some point an attempt at matching is likely to be made for every object that is onboarded, which may or may not result in a match. A matching engine can carry out the process. Like the other engines described herein, the matching engine may be a component of one or more regional platform instances.

The flowchart 1500 continues to module 1512 with merging. Merging refers to finding two objects that represent a common real world entity. A merging engine can carry out the process. Not all objects that are onboarded will necessarily be merged with other objects. Accordingly, the module 1512 could be skipped. Like the other engines described herein, the merging engine may be a component of one or more regional platform instances.

The flowchart 1500 continues to module 1514 with survivorship. Survivorship refers to, among other things, the technique of persisting EIDs. A survivorship engine can carry out the process. Not all objects that are onboarded will necessarily be merged, thereby triggering the survivorship, so the module 1514 could be skipped. Like the other engines described herein, the survivorship engine may be a component of one or more regional platform instances.

The flowchart 1500 continues to module 1516 with cross-tenant matching. Cross-tenant matching refers to the ability of a first tenant to use a first EID (or agent of the cross-tenant durable EID lineage-persistent RDBMS or other party that is given access) to match an object with a second EID at a second tenant. A cross-tenant matching engine, which can carry out the process, in part, by recognizing objects in two different tenants are associated with the same real world entity. It is not necessary for there to be actual cross-tenant matching for the flowchart 1500 to continue to module 1518. Like the other engines described herein, the cross-tenant matching engine may be a component of one or more regional platform instances.

The flowchart 1500 ends at module 1518 with lineage EID promotion. For example, a lineage EID promotion engine, which can carry out the process, in part, by persisting lineage EIDs and enables unmerging of objects in real time, without taking a datastore of the cross-tenant durable EID lineage-persistent RDBMS offline, at which point the flowchart 1500 can resume at one of several of the modules 1502-1518. Like the other engines described herein, the lineage EID promotion engine may be a component of one or more regional platform instances.

What is claimed is:

1. A system comprising:
one or more processors; and
memory storing instructions that, when executed by the one or more processors, cause the system to perform:
storing, by a multi-tenant platform, a plurality of datasets, wherein the plurality of datasets include personally identifiable information (PII);
establishing, by an API-centric dynamic masking system of the multi-tenant platform, a secure API layer, the secure API layer being an enforcement point for masking the PII;
defining, by the API-centric dynamic masking system, masking criteria that considers a structure of the PII, wherein the masking criteria is defined based on regular expressions;
masking, by the API-centric dynamic masking system at an API level, attributes of the PII based on the masking criteria, thereby preventing users from searching the masked data;
presenting, by a graphical user interface, the masked attributes to a user via the secure API layer;
securely unmasking, by the API-centric dynamic masking system, at least a portion of the masked attributes using unique API calls based on user-level permissions associated with the user;
presenting, by the graphical user interface, the unmasked attributes via the secure API layer;
centrally logging, by the API-centric dynamic masking system, the masking of the attributes of the PII and the unmasking of the at least a portion of the masked attributes;
generating, by the API-centric dynamic masking system, an audit trail based on the centrally logged information.

2. A system comprising:
one or more processors; and
memory storing instructions that, when executed by the one or more processors, cause the system to perform:
storing a plurality of entity records in a multi-tenant platform, each entity record including a set of attributes, wherein at least one attribute is designated as containing sensitive personally identifiable information (PII) and is configured with a data masking rule, wherein the data masking rule is associated with a particular masking pattern of a plurality of different masking patterns;
defining access permissions in a role-based access control (RBAC) model such that only users having a predefined privilege or role are allowed to view unmasked values of the sensitive attribute, while users without the privilege are restricted to masked values;
receiving a data retrieval request via an application programming interface (API) call from a requesting user for an entity record that includes the sensitive attribute;
automatically determining, by the multi-tenant platform in response to receiving the request, whether the requesting user's role is authorized to view the sensitive attribute unmasked or not, based on the RBAC permissions;
retrieving an actual value of the sensitive attribute for the entity record, the actual value remaining stored in an unmasked, non-redacted form in a secure datastore associated with the multi-tenant platform;
determining whether the requesting user is authorized or not authorized to view the sensitive attribute's actual value;
dynamically generating, in response to determining the user is not authorized to view the sensitive attribute's actual value, a masked representation of the actual value based on the associated data masking rule and masking pattern;
providing a response to the data retrieval request, wherein the response includes the entity record's data such that the sensitive attribute is presented as the masked representation if the user is unauthorized, or as the actual value if the user is authorized.

3. The system of claim 2, wherein the plurality of different masking patterns includes full masking of the attribute's value, partial masking that hides a specified subset of characters of the value, and a custom masking pattern defined by a user-provided masking expression, wherein the user-provided masking expression is defined by one or more regular expressions.

4. The system of claim 3, wherein the dynamically generating the masked representation comprises substituting a portion or entirety of the actual value with masked characters as specified by the masking pattern.

5. The system of claim 4, wherein the instructions further cause the system to perform allowing disclosure of the actual value in the output in response to determining that the requesting user is authorized to view the sensitive attribute's actual value.

6. The system of claim 2, wherein the data masking rule for the sensitive attribute is configurable through a graphical user interface of the multi-tenant platform, thereby allowing a user to select the masking pattern or define the custom masking expression, and to specify which user roles have unmasking privileges for that attribute in order for different attributes to have different masking patterns and permission settings within the multi-tenant platform.

7. The system of claim 6, wherein the multi-tenant platform is configured to access and utilize the actual values of masked sensitive attributes during automated duplicate detection or merge operations, and retrieval of those attributes complies with the masking rules, thereby maintaining data privacy without hindering the accuracy of entity resolution within the multi-tenant platform.

8. The system of claim 2, wherein responses delivered via different access channels all consistently apply the masking rules, including displaying masked values in the platform's graphical user interface for users lacking unmask permissions, returning masked values in API responses and data export files for unauthorized consumers, and logging or auditing any events of actual values being revealed to authorized users for compliance monitoring.

9. The system of claim 2, wherein the multi-tenant platform simultaneously enforces the masking rule on an external output path associated with the requesting user for at least one externally observable channel including any of a user-interface response, an API response, and a data-export output, and (ii) uses the actual value of the sensitive attribute to perform match-and-merge processing operations using the actual value, without including the actual value in the external output path when the requesting user lacks the predefined privilege.

10. A method implemented by a computing system including one or more processors and storage media storing machine-readable instructions, wherein the method is performed using the one or more processors, the method comprising:
storing a plurality of entity records in a multi-tenant platform, each entity record including a set of attributes, wherein at least one attribute is designated as containing sensitive personally identifiable information (PII) and is configured with a data masking rule, wherein the data masking rule is associated with a particular masking pattern of a plurality of different masking patterns;
defining access permissions in a role-based access control (RBAC) model such that only users having a predefined privilege or role are allowed to view unmasked values of the sensitive attribute, while users without the privilege are restricted to masked values;
receiving a data retrieval request via an application programming interface (API) call from a requesting user for an entity record that includes the sensitive attribute;
automatically determining, by the multi-tenant platform in response to receiving the request, whether the requesting user's role is authorized to view the sensitive attribute unmasked or not, based on the RBAC permissions;
retrieving an actual value of the sensitive attribute for the entity record, the actual value remaining stored in an unmasked, non-redacted form in a secure datastore associated with the multi-tenant platform;
determining whether the requesting user is authorized or not authorized to view the sensitive attribute's actual value;
dynamically generating, in response to determining the user is not authorized to view the sensitive attribute's actual value, a masked representation of the actual value based on the associated data masking rule and masking pattern;
providing a response to the data retrieval request, wherein the response includes the entity record's data such that the sensitive attribute is presented as the masked representation if the user is unauthorized, or as the actual value if the user is authorized.

11. The method of claim 10, wherein the plurality of different masking patterns includes full masking of the attribute's value, partial masking that hides a specified subset of characters of the value, and a custom masking pattern defined by a user-provided masking expression, wherein the user-provided masking expression is defined by one or more regular expressions.

12. The method of claim 11, wherein the dynamically generating the masked representation comprises substituting a portion or entirety of the actual value with masked characters as specified by the masking pattern.

13. The method of claim 12, wherein the instructions further cause the system to perform allowing disclosure of the actual value in the output in response to determining that the requesting user is authorized to view the sensitive attribute's actual value.

14. The method of claim 10, wherein the data masking rule for the sensitive attribute is configurable through a graphical user interface of the multi-tenant platform, thereby allowing a user to select the masking pattern or define the custom masking expression, and to specify which user roles have unmasking privileges for that attribute in order for different attributes to have different masking patterns and permission settings within the multi-tenant platform.

15. The method of claim 14, wherein the multi-tenant platform is configured to access and utilize the actual values of masked sensitive attributes during automated duplicate detection or merge operations, and retrieval of those attributes complies with the masking rules, thereby maintaining data privacy without hindering the accuracy of entity resolution within the multi-tenant platform.

16. The method of claim 10, wherein responses delivered via different access channels all consistently apply the masking rules, including displaying masked values in the platform's graphical user interface for users lacking unmask permissions, returning masked values in API responses and data export files for unauthorized consumers, and logging or auditing any events of actual values being revealed to authorized users for compliance monitoring.

17. The method of claim 10, wherein the multi-tenant platform simultaneously enforces the masking rule on an external output path associated with the requesting user for at least one externally observable channel including any of a user-interface response, an API response, and a data-export output, and (ii) uses the actual value of the sensitive attribute to perform match-and-merge processing operations using the actual value, without including the actual value in the external output path when the requesting user lacks the predefined privilege.

18. A non-transitory computer-readable medium comprising instructions that, when executed, cause one or more processors to perform:
storing a plurality of entity records in a multi-tenant platform, each entity record including a set of attributes, wherein at least one attribute is designated as containing sensitive personally identifiable information (PII) and is configured with a data masking rule, wherein the data masking rule is associated with a particular masking pattern of a plurality of different masking patterns;
defining access permissions in a role-based access control (RBAC) model such that only users having a predefined privilege or role are allowed to view unmasked values of the sensitive attribute, while users without the privilege are restricted to masked values;
receiving a data retrieval request via an application programming interface (API) call from a requesting user for an entity record that includes the sensitive attribute;
automatically determining, by the multi-tenant platform in response to receiving the request, whether the requesting user's role is authorized to view the sensitive attribute unmasked or not, based on the RBAC permissions;
retrieving an actual value of the sensitive attribute for the entity record, the actual value remaining stored in an unmasked, non-redacted form in a secure datastore associated with the multi-tenant platform;
determining whether the requesting user is authorized or not authorized to view the sensitive attribute's actual value;
dynamically generating, in response to determining the user is not authorized to view the sensitive attribute's actual value, a masked representation of the actual value based on the associated data masking rule and masking pattern;
providing a response to the data retrieval request, wherein the response includes the entity record's data such that the sensitive attribute is presented as the masked representation if the user is unauthorized, or as the actual value if the user is authorized.

19. The non-transitory computer-readable medium of claim 18, wherein the plurality of different masking patterns includes full masking of the attribute's value, partial masking that hides a specified subset of characters of the value, and a custom masking pattern defined by a user-provided masking expression, wherein the user-provided masking expression is defined by one or more regular expressions.

20. The non-transitory computer-readable medium of claim 19, wherein the dynamically generating the masked representation comprises substituting a portion or entirety of the actual value with masked characters as specified by the masking pattern.
